(19) United States
(12) Patent Application Publication
(10) Pub. No.: US 2002/0091550 A1
(43) Pub. Date: Jul. 11, 2002

(54) System and method for real-time rating, underwriting and policy issuance

(76) Inventors: Mitchell Franklin White, Atlanta, GA (US); Joseph Crabill, Atlanta, GA (US); Jane A. Davis, Atlanta, GA (US); Kris Furstenberg, Newnan, GA (US); M. Kevin Geraghty, Marietta, GA (US); Craig Guarnieri, Powder Springs, GA (US); Anthony Rogers, Jonesboro, GA (US); Laura Severinsen, Duluth, GA (US); Steven R. Smith, Alpharetta, GA (US); William Stoddart, Marietta, GA (US)

Correspondence Address: RED HOT LAW GROUP OF ASHLEY LLC, THE BILTMORE, 817 W PEACHTREE STREET, NW, SUITE 400, ATLANTA, GA, 30308-1138, US

(21) Appl. No.: 09/896,392

(22) Filed: Jun. 29, 2001

Related U.S. Application Data
(60) Provisional application No. 60/214,923, filed on Jun. 29, 2000.
(60) Provisional application No. 60/253,108, filed on Nov. 27, 2000.

(51) Int. Cl. G06F 17/60

(52) U.S. Cl. 705/4

(57) ABSTRACT

The present invention is directed to systems and methods for real-time rating, underwriting and policy issuance for the insurance industry. A process according to the present invention, as may be implemented via an appropriate computer environment, will include several steps in providing real-time rating, underwriting and policy issuance. Accordingly, identification information associated with a particular applicant is received. A connection is established with one or more information sources that may have data related to the applicant that may be relevant to the real-time rating and underwriting of an insurance policy for the applicant. A request for relevant data is transmitted over the respective connections. The relevant data is received from the information sources. Based upon the received relevant data, an offer of insurance is generated for the particular applicant. In some embodiments, a dynamic pricing factor may be used in generating the offer. The generated offer is then communicated to the applicant via an offer output device.

### CROSS-REFERENCE TO RELATED PATENT APPLICATION

This application claims the benefit, pursuant to 35 U.S.C. 517 19(e), of applicant's provisional U.S. patent applications Ser. No. 60/214,923, filed Jun. 29, 2000, entitled “SYSTEM AND METHOD FOR REAL-TIME RATING, UNDERWRITING AND POLICY ISSUANCE” and Ser. No. 60/253,108, filed Nov. 27, 2000, entitled “SYSTEM AND METHOD FOR REAL-TIME RATING, UNDERWRITING AND POLICY ISSUANCE”. By this reference, the contents of these applications are incorporated herein in their entireties for all purposes.

### BACKGROUND OF INVENTION

1. Field of Invention

The present invention relates to a system and method for real-time rating, underwriting and policy issuance. More particularly, the invention relates to a system and method for applying computer and networking technology to the field of real-time rating, underwriting and insurance policy issuance.

2. Description of Related Art

The Internet is a global network of connected computer networks. Over the last several years, the Internet has grown in significant measure. A large number of computers on the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as GOPHER and FTP.

Information on the Internet can be accessed through the use of a Uniform Resource Locator (URL). A URL uniquely specifies the location of a particular piece of information on the Internet. A URL will typically be composed of several components. The first component typically designates the protocol by with the address piece of information is accessed (e.g., HTTP, GOPHER, etc.). This first component is separated from the remainder of the URL by a colon (‘:’). The remainder of the URL will depend upon the protocol component. Typically, the remainder designates a computer on the Internet by name, or by IP number, as well as a more specific designation of the location of the resource on the designated computer. For instance, a typical URL for an HTTP resource might be:

http://www.server.com/dir1/dir2/resource.htm

where http is the protocol, www.server.com is the designated computer and /dir1/dir2/resouce.htm designates the location of the resource on the designated computer.

Web servers host information in the form of Web pages; collectively the server and the information hosted are referred to as a Web site. A significant number of Web pages are encoded using the Hypertext Markup Language (HTML) although other encodings using the eXtensible Markup Language (XML) or the Standard Generic Markup Language (SGML) are becoming increasingly more common. The published specifications for these languages are incorporated by reference herein. Web pages in these formatting languages may include links to other Web pages on the same Web site or another. As will be known to those skilled in the art, Web pages may be generated dynamically by a server by integrating a variety of elements into a formatted page prior to transmission to a Web client. Web servers and information servers of other types await requests for the information that they receive from Internet clients.

Client software has evolved that allows users of computers connected to the Internet to access this information. Advanced clients such as Netscape's Navigator and Microsoft's Internet Explorer allow users to access software provided via a variety of information servers in a unified client environment. Typically, such client software is referred to as browser software.

All U.S. property and casualty insurers currently use a “free-look” period during which they underwrite policy applications and collect additional information as part of their underwriting evaluation. During this “free-look” period (typically several weeks long), applicants are “bound” and enjoy insurance coverage under the application, but the insurer may change its rate, cancel the policy, or offer coverage on less favorable terms at any time during the “free-look” period. The length and conditions of the “free-look” period vary based on state insurance laws and the line of business, but every U.S. property and casualty insurer utilizes the “free-look” period in some form.

Of the more than 3702 property and casualty insurers licensed in one or more U.S. jurisdiction, none has proposed creating an insurance product based solely on what information is available immediately, and the technology that can support the collection of such information. A major principle of insurance underwriting is that the more information an insurer can collect on an applicant, the better pricing or underwriting decision the insurer can make. This principle, as traditionally applied, holds that even if underwriting information takes a long time to obtain, is difficult to find, or is expensive, it is important to collect the information. A significant amount of this information may be collected, stored and accessed via computer networks such as the Internet.

Even prior art online systems that provide insurance quotes to consumers use a manual underwriting process during a “free-look” period. In contrast, the systems and methods of the present invention provide consumers with an offer of insurance where underwriting occurs in real-time using information that is immediately available. Offers generated in this manner are not subject to revision during a “free-look” period as provided by prior art systems and methods.

Insurance faces huge challenges in the coming decade. As an information-based industry with an intangible product, new technology presents significant opportunity for companies that can effectively exploit it and a fatal threat to companies that cannot adapt. Dynamic pricing is a competitive strategy that complements and takes advantage of the new models of customer engagement. Dynamic pricing maximizes the seller's economic benefit by finding the optimal tradeoff between a customer's likelihood to accept an offer and the revenue value of that offer.

Dynamic pricing refers to a seller's ability to adjust price in response to market demand and customers price sensitivity. Optimal dynamic pricing trades off a customers likelihood to accept an offer with the revenue value of the offer to find the maximum expected benefit to the seller in terms of revenue generation and other business objectives.

Dynamic pricing produces value through segmentation. The insurance industry is unique in the degree to which its unit costs are sensitive to customer segments. This has created a pricing environment that is focused on cost-based pricing and detailed segmentation by customer characteristics. In contrast, dynamic pricing splits demand into segments that may or may not reflect explicit customer characteristics. FIGS. 5A and 5B demonstrate these principles graphically. FIG. 5A demonstrates a traditional view of demand and pricing whereas FIG. 5B depicts the potential realization derived from greater segmentation through dynamic pricing.

Dynamic pricing also produces value by extracting a signal about competitive position from customer behavior or from comparison-shopping. The automated customer engagement model of an online environment, such as with various embodiments according to the present invention, creates an opportunity for rich data capture and quick response that can support very precise dynamic pricing decisions. Other channels may not have this kind of flexibility, but designing dynamic pricing attributes into products will create revenue enhancement opportunities through responsiveness to the market voice.

Dynamic pricing has had significant success in recent years in the Pricing and Revenue Management programs launched by service industries. These tend to be high fixed cost/low variable cost industries with capacity limitations and the luxury of advanced knowledge of consumption through a reservation process. Insurance, by contrast, has a high variable cost/low fixed cost structure, which means that price moves have a greater impact on profitability. This is because higher volumes erode the fixed cost per unit sale burden but not the variable cost. Insurance also has a variable cost that is dependent on individual customer characteristics. This means that insurance already practices differential pricing. Dynamic pricing exploits customer behavior information to make these price differentials account for customer price sensitivity.

Introduction of dynamic pricing to service industries has shown significant social benefit. In the service industries average rates tend to be lower. Revenues are enhanced because products are accessible to a wider market. Since dynamic pricing extracts its benefit to the company from the customer, it tends to improve industry profitability rather than sharpen competition for market share. Broad adoption of intelligent pricing strategies benefits companies from a solvency perspective, price-sensitive consumers through lower rates, and higher yield customers through product features tailored to their needs.

The principals of dynamic pricing can be applied in a variety of ways. The key change to the insurance industry business process is to adopt a more operational approach to price management. This means making more targeted price adjustments in shorter timeframes than current practice. Operational price management relies on consistent application of statistically sound pricing decisions.

Many operational price management environments rely on tactically focused decision support systems that monitor customer behavior and produce price recommendations for pricing analysts to implement as they see fit. Alternatively, automated price management can be effective in pricing environments with high volumes. Automated pricing uses computer programs to update prices without human intervention. Analysts set parameters and decision rules that influence the systems performance, but rarely control individual pricing decisions. Automated pricing combines computer and communications technology with control systems design and the economics of price to offer customers a price that maximizes the expected economic benefit to the seller.

By creating a real-time rating, underwriting and policy issuance process, an insurer can 1) be able to guarantee customers that their prices will not change after the application process is completed; 2) remove considerable underwriting and processing expense from the policy-issuance process, enabling it to offer lower prices; and 3) substantially eliminate bad debt expense by calculating and collecting insurance premiums immediately. The use of dynamic pricing principles in certain embodiment may further enhance the advantages of the present invention.

### SUMMARY OF THE INVENTION

The present invention is directed to systems and methods for real-time rating, underwriting and policy issuance for the insurance industry. A typical system embodiment of the present invention will include a system data store for storing applicant related information, a system processor having one or more processing units and a connection, or link, to a communication channel allowing communication between the system and potential applicants. The system processor will typically be responsible for handling interactions with the applicant and data processing. Data storage and retrieval functionality may be provided by either the system processor or data storage processors associated with the data store. Applicants will typically interact with the environment via a user computer connected to the system via a computer network, such as the Internet, however, other suitable connection types may be used.

A process according to the present invention, as may be implemented in the typical system briefly described above, will include several steps in providing real-time rating, underwriting and policy issuance. Accordingly, identification information associated with a particular applicant is received. A connection is established with one or more information sources that may have data related to the applicant that may be relevant to the real-time rating and underwriting of an insurance policy for the applicant. A request for relevant data is transmitted over the respective connections; such request will typically include some request data derived from the identification information associated with the particular applicant so that the information sources can locate and supply any available relevant data. The relevant data is received from the information sources and aggregated. Based upon the received relevant data, an offer of insurance is generated for the particular applicant. In some instances, the generated offer may be a statement indicating a denial, which may result from a lack of sufficient relevant information or a determination that the applicant does not meet coverage requirements. In other instances, an offer may be made despite lack of particular relevant information; in which case, the offer generation may factor this lack into the offer generation process. Some embodiments may utilize a dynamic pricing factor in the offer generation process. Dynamic pricing is a competitive strategy that complements the seller's business objectives by finding the optimal tradeoff between a customer's likelihood to accept an offer and the revenue value of that offer. In contrast to current insurance industry practice, dynamic prices can be generated without an explicit understanding of the underlying customer characteristics. Instead, indicators or signals are derived from demand and consumption information captured at customer contact points. Prices are adjusted based on what consumer behavior reveals about price sensitivity. The generated offer is then communicated to the applicant via an offer output device such as a user computer, a facsimile, a telephone or other suitable mechanism.

This invention in one aspect involves designing the insurance product around technology that enables all of the data collection, policy information, data verification, and underwriting to be performed as part of the consumer application process. At the end of the application process, an insurer is able to return to the customer an offer of insurance. This offer of insurance, unlike a traditional quote, is not subject to change based on the company's underwriting or data collection process. The customer knows, immediately, what his, her, or its rate will be, and this price is not subject to change.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 is a process diagram depicting for developing real-time processes for insurance offer generation.

FIG. 2 is a flowchart of a typical process offer generation sequence according to the present invention.

FIG. 3 is a diagram of the architecture of a typical environment according to the present invention.

FIG. 4 is a process diagram depicting an embodiment of a method according to the present invention.

FIGS. 5A-5B depict graphs of price versus demand where the white regions represent potential realization of revenue.

FIG. 6 is a block diagram depicting the software component in a typical embodiment using dynamic pricing.

FIGS. 7A-7B depict graphs of conversion rates versus days to policy expiration for the months of November and December of 2000, respectively.

### DETAILED DESCRIPTION OF THE INVENTION

A preferred embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. In the foregoing discussion, the following terms will have the following definitions unless the context clearly dictates otherwise.

BI—Bodily Injury. An insurance coverage type that pays for injuries suffered by third parties as a result of an incident associated the insured.

PD—Property Damage. An insurance coverage type that pays for property damage suffered by third parties as a result of an incident associated the insured.

UM—Uninsured Motorist. An insurance coverage type that pays for losses caused by an uninsured motorist.

UIM—Under Insured Motorist. An insurance coverage type that pays for losses caused by a motorist with insufficient insurance to cover the loss.

UMBI—Uninsured Motorist Bodily Injury. An insurance coverage type that pays for bodily injury caused by a motorist with insufficient insurance to cover the loss.

PIP—Personal Injury Protection. An insurance coverage type that pays for personal injury losses suffered by the insured.

Comp—Comprehensive Insurance. An insurance coverage type that pays for all losses suffered by the insured.

Coll—Collision—Collision Insurance. An insurance coverage type that pays for vehicle damage suffered by the insured.

MVR—Motor Vehicle Report. A report of the items on an insurance applicant's legal driving record.

CLUE (Equifax Inc., Atlanta, Ga.)—Comprehensive Loss Underwriting Exchange—Report shows claim recap for Risk and Subject including credit information.

Vehicle Use—manner in which insured uses he vehicle

Pleasure—primarily used for personal reasons, not business or work related

Business—used primarily for business or work related activity

Artisan—used specifically in the performance of work, such as carrying tools

Drive to and from work and school

Vehicle Type

Private Passenger Auto—as per federal description

Pickup—a light truck

Van

Relationship to NI (Named Insured)—Named Insured the primary holder of the insurance policy.

Self—the named insured

Spouse—marital partner of the named insured

Parent—parent of the named insured or parent of the named insured's spouse

Partner—Domestic partner that is not a spouse

Child at home—child of named insured or child of named insured spouse domiciled with the named insured

Child away at School (in state)—child of named insured or child of named insured spouse with a different residence because of attendance at a third level educational institution

Other—Related—relative of the named insured not described above

Other—Not related-non-relative of the named insured

Driver Types

Rated—Someone covered by the policy

Excluded—member if the household not included on the policy

List Children—non driving children in the household

Nondriver—non drivers in the household

Marital Status

Single

Married

Divorced

Widowed

GMAC Discounts

GMAC Mortgage—A discount offered to policy holders that also have a mortgage with GMAC

GMAC Auto Loan—A discount offered to policy holders that also have an auto loan with GMAC

GMAC Auto Lease—A discount offered to policy holders that also have an auto lease with GMAC

GM Credit Card—A discount offered to policy holders that also have a credit card with GMAC

GM Demand/Smart Note—A discount offered to policy holders that also have GMAC Demand or Smart notes

Non Chargeable Incident (NCI)—A traffic incident associated with a customer but for which the customer was not held responsible

Not at fault accident (recorded on the CLUE report with a coverage of MP, PIP, CP,or UM).

At fault accident (waived)—do not display to user

Comprehensive loss: under $1,000

Comprehensive loss: $1,000 or greater

Medical Payments loss

Nonchargable which cannot be assigned to a specific driver (attribute applied to Named Insured)

Other nonchargable violations

Personal Injury Protection (PIP) loss

Underinsured Motorists loss

Uninsured Motorists loss

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

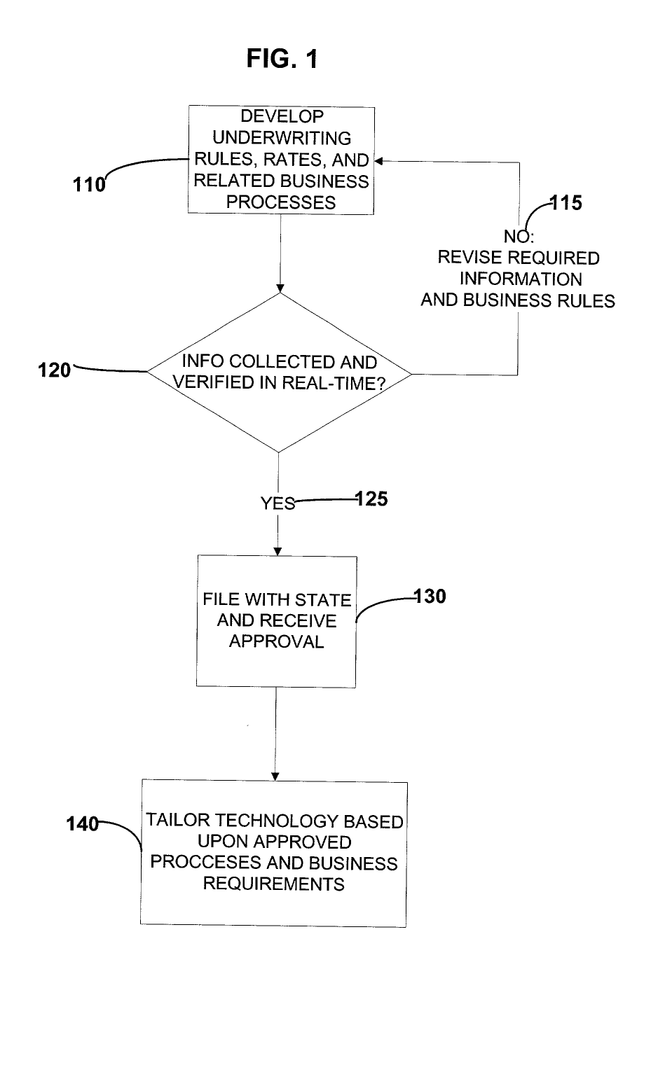

In one embodiment of the present invention underwriting rules and rates are created, and processes are designed, to accommodate information that is verifiable and collectable immediately (in real-time). Depending upon the line of business and individual jurisdictional statutes and regulations, these rules, rates and processes will have to be filed and approved in each jurisdiction in which an insurer wishes to introduce the product. Examples of the product development workflow and the application process are seen in FIG. 1. This diagram is applicable across all property and casualty insurance products, including both personal lines and commercial lines. Examples include, but are not limited to the following personal lines polices: private passenger automobile, homeowners (including tenants' and condominium owners' policies), dwelling fire, personal umbrella, inland marine, recreational vehicle, motorcycle, and personal watercraft. Examples also include, but are not limited to, the following commercial lines policies: business owners' policies (BOPs), commercial vehicle, general liability, commercial umbrella, package policies, commercial property, and workers compensation.

In step 110, a set of underwriting rules, rates and related business processes are developed. This set is reviewed to determine whether the customer information required can be collected and verified in real-time in step 120. If not (115), the set is revised and reviewed again. If the answer to the review is yes (125), a proposal based upon the set if submitted to the individual jurisdiction (for example, an individual state in the United States) in step 130. Once jurisdictional approval has been obtained, or in some embodiments concurrently with the approval process, technology for real-time rating, underwriting and policy issuance are tailored according to the set of developed underwriting rules, rates and business processes.

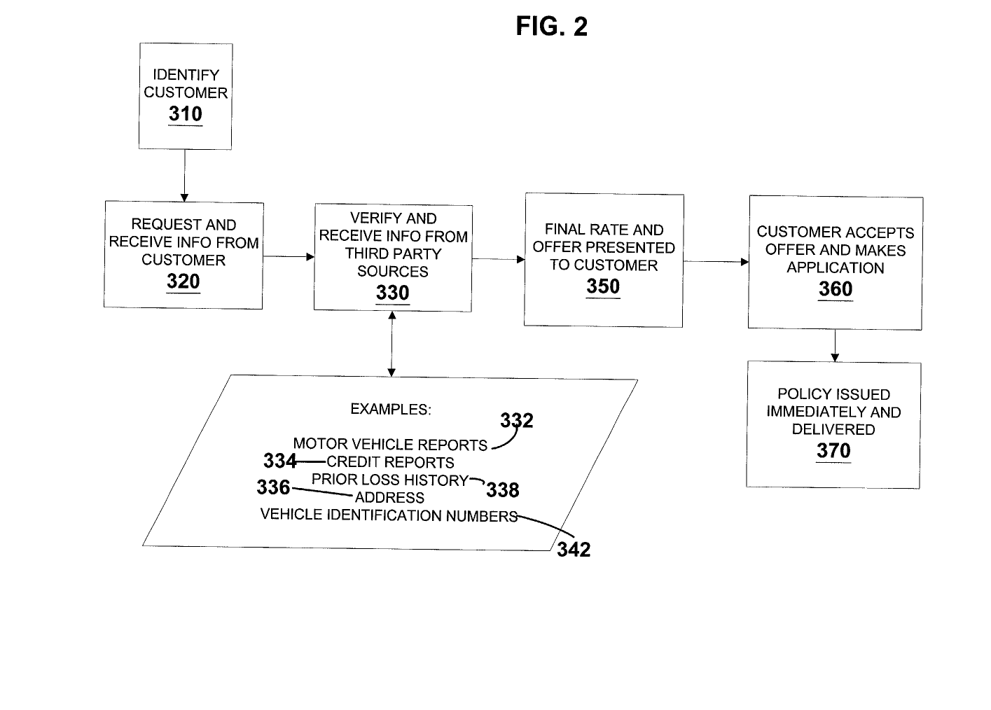

FIG. 2 depicts a flowchart of a typical offer generation process. A customer is identified in step 310. Information concerning and/or identifying the customer are requested and received in step 320. This received information is verified and/or supplemented in step 330 through access to third-party information sources. Such verification or supplementation may include, without limitation, information such as motor vehicle reports (332), credit reports (334), prior loss history (338), address (336), and vehicle identification numbers (342). A final rate and offer is presented to the customer in step 350. If the customer accepts the offer, application is made in step 360. Either a separate step (not shown), or as part of step 360, the customer may provide payment information, which may, in some embodiments, be verified either internally or via a third-party verification service. In step 370, the policy is issued and delivered to the customer. Additional embodiments of the present invention are described in greater detail below.

As part of this process, each application can be made immediately, through whichever medium is fastest and/or most efficient. For example, an application could be made electronically, through the Internet, an Intranet, or other similar method such as direct communications link; however, alternative means of entry such as automated telephone response systems and automated facsimile with optical character recognition support are also possible within the scope of the present invention. Since the underwriting and processing is performed immediately, in real-time, the declarations page and all related documents can be returned electronically, through any suitable communication method. Paper document exchanges are not necessarily required, depending upon customer preference, state regulatory requirements and technology available.

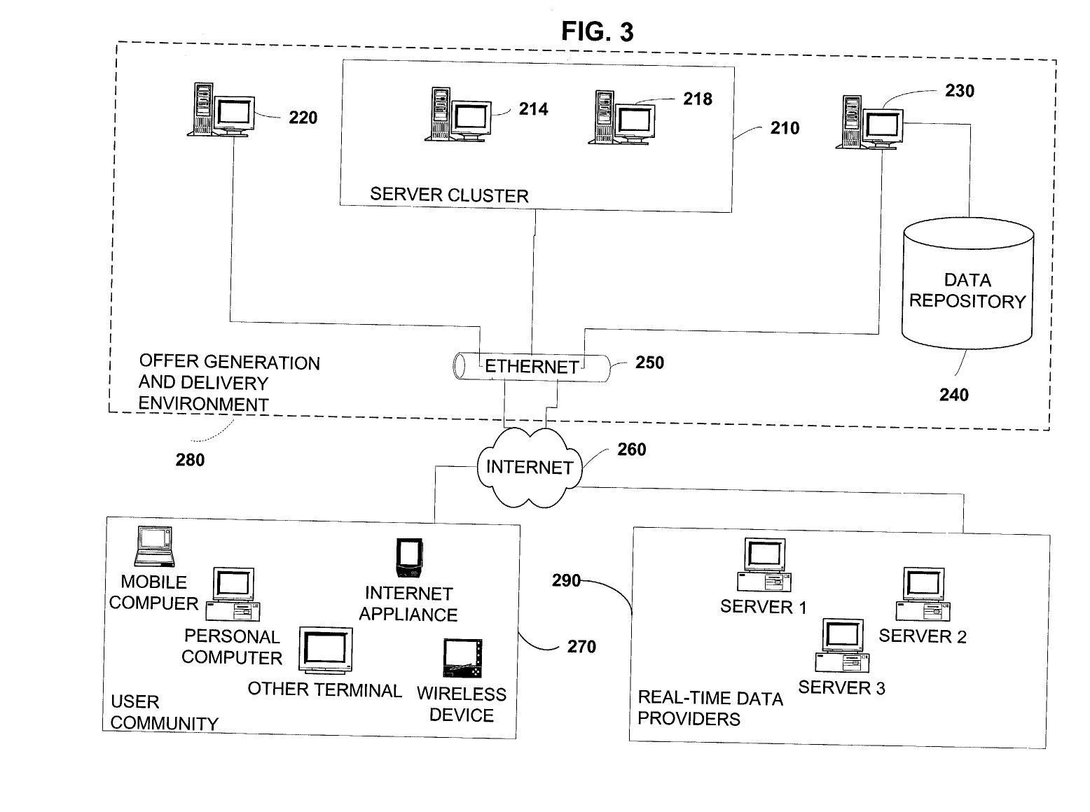

FIG. 3 depicts a typical environment according to the present invention. Members of the user community using suitable devices 270 can obtain an offer of insurance via an offer generation and delivery environment (offer environment) 280 via a communications channel such as the Internet 260. A typical offer environment 280 will include a cluster of servers 210 including one or more servers 214, 218 supporting offer generation as described above and delivery of such offers. The offer environment may include a separate system data store for storing data associated with offers and users; alternatively, the system data store may use internal storage devices connected to one or more of the server processors (214, 218) of the server cluster 210. In embodiments where a single processor provides supports all functionality of the environment, a local hard disk drive may serve as the system data store. Such a data store, in a typical embodiment, may be implemented as a database system 230 with an external or internal data repository 240 as described more fully below. The offer environment 280 will also typically include a communication channel such as Ethernet 250 supporting communication among components of the environment 280 although other suitable channels may be used (e.g. direct or indirect connections, token ring, dial-up, etc.). The offer environment 280 may also optionally include one or more load balancing servers 220 for distributing work among the components of the environment 280. Real-time information providers 290 may supply information used in generating offers; these information providers communicate with the offer environment 280 via a communication channel such as the Internet 260 or other suitable connection (e.g. dedicated communication line, dial-up connection etc.).

An offer generation and delivery environment (offer environment) 280 may include a server cluster 210 of one or more servers (e.g. 214, 218) that provides offer generation, policy generation and policy delivery functionality. These, or other servers (not shown), may support access to the environment by members of the user 270. Access to the environment by these various users may be via any suitable communication channel, which in a typical embodiment will be a computer network such as the Internet 260 and/or Ethernet 250. In other environments, access may be via other forms of computer network, direct dial-up connection, dedicated connection or other suitable channel as would be known to those skilled in the art. Some embodiments may use and/or require a combination of communication vehicles, such as those previously described, to serve as the communication channel. In some embodiments the access channel may provide security features; for instance, a secure socket layer (SSL) may be used with respect to an embodiment using the Internet 260 as the access communication channel. The one or more servers may include or connect to a data store for storing customer data and/or parameter necessary to generate offers, generate policies and to deliver policies.

The various components of the environment 280 may communicate with each other through any suitable communication architecture including, but not limited to, a computer network such as a Ethernet 250, token ring network or the Internet 260; a direct connection such as a bus connection, parallel or serial connection, null modem connection or wireless connection utilizing an appropriate communication protocol such as BLUETOOTH; a dial-up connection; and appropriate combinations thereof. In embodiments where a single computer may provide all functional components, the communication may occur via bus connections, inter-process communication, shared files or some combination of these methods or other commonly utilized communication mechanisms.

The architecture, seen in FIG. 3, use the Internet 260 and an Ethernet 250 as communication channels allowing access to the environment by various members of the user community 270 and allowing communication between the environment and third-party sources of customer data and/or sources of verification of customer data 290. The environments uses a computer network such as the depicted Ethernet 250 to allow communication among the components of the environment; a router (not shown) may be included in the environment to manage such communication within the internal network as well as managing the interface between the internal network and the Internet 260. The functionality of the environment is spread among a server cluster 210, a data store 230, 240 and, in some embodiments, a load-balancing device 220. Where a load-balancing device 220 is present, the device may be responsible for allocating and managing distribution of access among various elements within the server cluster 210 and/or the data store 230, 240. Users may access the environment through standard Web browser software or via specialized access software adapted for interfacing with the offer environment 280.

The server cluster 210 provides the offer generation and policy generation/issuance functionality of the environment 280. In some embodiments, the server cluster 210 may be divided into access servers and application servers where the access servers provide electronic access functionality such as by electronic mail server(s) and/or Web server(s) and the application servers provide the offer generation and policy generation/issuance functionality. In some such embodiments, the one or more servers (e.g. 214, 218) in the server cluster 210 may be supported via Intel-compatible hardware platforms preferably using at least a PENTIUM III class microprocessor (Intel Corp., Santa Clara, Calif.). In some embodiments, functionality may be distributed across multiple processing elements. The term processing element may be a process running on a particular piece, or across particular pieces, of hardware, a particular piece of hardware or either as the context allows. The hardware platform would have an appropriate operating system such as WINDOWS 2000 Server (Microsoft, Redmond, Wash.), WINDOWS/NT Server (Microsoft, Redmond, Wash.), Solaris (Sun Microsystems, Palo Alto, Calif.), or LINUX (or other UNIX variant).

Depending upon the hardware/operating system platform, appropriate server software may be included to support the desired application, email and Web server functionality. The Web server functionality may be provided via an Internet Information Server (Microsoft, Redmond, Wash.), an Apache HTTP Server (Apache Software Foundation, Forest Hill, Md.), an iPlanet Web Server (iplanet E-Commerce Solutions—A Sun—Netscape Alliance, Mountain View, Calif.) or other suitable Web server platform. The email services may be supported via an Exchange Server (Microsoft, Redmond, Wash.), sendmail or other suitable email server.

Application servers in some embodiments may be iPlanet Application Servers (iplanet E-Commerce Solutions—A Sun—Netscape Alliance, Mountain View, Calif.), WebSphere Servers (International Business Machines, Armonk, N.Y.), Tomcat Java Servelet/JSP Engine (Apache Software Foundation, Forest Hill, Md.) or Citrix MetaFrame (Citrix Systems, Inc., Ft. Lauderdale, Fla.). In one embodiment, the business application services may be provided through programmed pages on the Web server; such pages may use ActiveX, VBScript, Java Applet and/or Servelet technology to provide server side business logic and may use ActiveX or JavaScript to support client side business logic. An application server may also be used in the environment to provide policy management, creation and update functionality. Such an application server may also be responsible for initial determination of the rate. In some embodiments, a Diamond System (Applied Systems, Inc., University Park, Ill.) may provide such policy management functionality. A dynamic pricing engine, as further described below, may also run on one of the environment's application servers in some embodiments.

The data store provides for the storage and, potentially, the management of the data required by the environment. A typical data store will include one or more storage devices, and in some embodiments, may include one or more data servers. The data store depicted in FIG. 3 uses a server 230 and a data repository 240. These depictions are representative only, and consequently, other data store architectures may have multiple servers and storage elements. Information concerning different users (including applicants, administrators, underwriters, agents, etc.), different real-time vendors (including server access and addressing parameters), policy templates, pricing tables, underwriting tiers may be stored in the data store. It will be understood by those of skill in the art that these different types of information may be logically or physically segregated within a single system data store; multiple related data stores accessible through a unified management system, which together serve as the system data store; or multiple independent data stores individually accessible through disparate management systems, which may in some embodiments be collectively viewed as the system data store.

The architecture of the data store may vary significantly in different embodiments. In several embodiments, database(s) are used to store and manipulate the data; in some such embodiment, one or more relational database management systems, such as SQL Server (Microsoft, Redmond, Wash.), ACCESS (Microsoft, Redmond, Wash.), ORACLE 8i (Oracle Corp., Redwood Shores, Calif.), Ingres (Computer Associates, Islandia, N.Y.), or Adaptive Server Enterprise (Sybase Inc., Emeryville, Calif.), in connection with a variety of storage devices/file servers that may include, in some embodiments, an tape library such as Exabyte X80 (Exabyte Corporation, Boulder, Colo.), a storage attached network (SAN) solution such as available from (EMC, Inc., Hopkinton, Mass.), a network attached storage (NAS) solution such as a NetApp Filer 740 (Network Appliances, Sunnyvale, Calif.), or combinations thereof. In other embodiments, the data store may use database systems with other architectures such as object-oriented, spatial, object-relational or hierarchical or may use other storage implementations such as hash tables or flat files or combinations of such architectures.

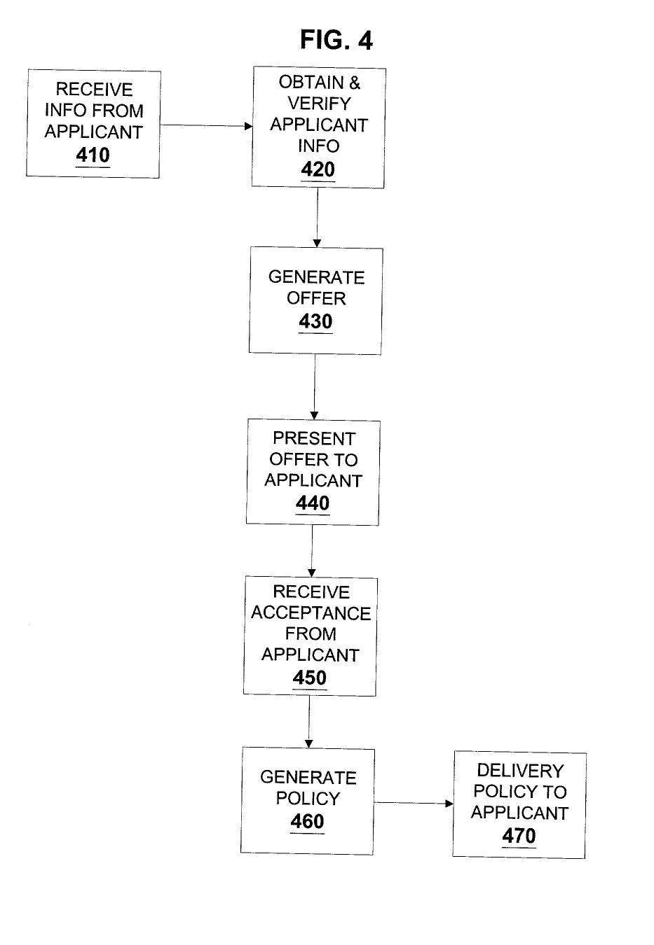

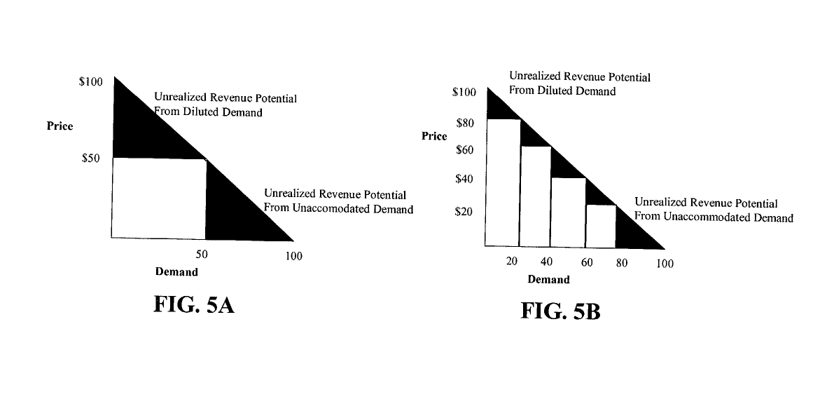

FIG. 4 provides a flowchart of a typical method according to the present invention, as further described below with respect to various embodiments. In some embodiment, one or more processors within the environments as described above may execute the steps in such methods. In other embodiments, any suitable computer readable storage device, including primary storage such as RAM, ROM, cache memory, etc. or secondary storage such as magnetic media including fixed and removable disks and tapes; optical media including fixed and removable disks whether read-only or read-write; paper media including punch cards and paper tape; or other secondary storage as would be known to those skilled in the art, may store instruction that upon execution by one or more processors cause the one or more processors to execute the steps in such methods.

In step 410, information is obtained from the customer. In some embodiments, this information may be simply identification information, such as a social security number. In other embodiments, the information will include at least identification information; other types of information that may be requested could include, without limitation, name; contact information such as address, telephone number, etc.; type of home; number of people residing with applicant; marital status; information concerning vehicles driven such as make, model, year, vehicle identification number (VIN), etc.; prior insurance history such as prior insurer, policy number, coverage limitations, expiration date, etc.; and underwriting questions such as related to insurance/fraud convictions, vehicle alterations and undisclosed drives.

This step may, in some embodiments, be preceded by a transmission of a request for such information to an output device associated with the applicant; this output device may be the same as, or different from, the output device as described below for presenting the generated offer and/or delivering the issued policy. The output device will usually be a computer, a telephone, a facsimile machine or some combinations thereof; however, any suitable output device for conveying the request to the applicant may be used within the scope of the present invention. Where the output device is a computer, the computer will typically use a monitor as a display device; however, the display device may also be a speaker or other audio display, a tactile display, a printer or other print display, combinations of these or combinations of these along with a monitor. In some of these embodiments, the transmission will include a form for the applicant to complete with the information to be obtained and receiving the information will include receiving the completed form and parsing the desired information from the completed form. Typically, this interaction will occur via a Web based interface where the form is presented to the applicant in one or more parts via Web browser software; upon submission of the form, or each part thereof, the information entered by the applicant is received. However, other interactive processes may be used such as facsimile or email delivery of the form to the applicant and facsimile or email return of the completed form. In one such embodiment, the returned form is received in digital form and optical character recognition software is used to discern the entered information. Similarly, an automated voice response system with suitable voice recognition software could analogously be used for presenting the form and receiving the desired information. Finally, form delivery and return could be through different media such as delivery via a facsimile with either Web or telephone return.

In step 420, contact is established with one or more information sources. A request is transmitted to one or more of the information sources to which contact was established. In response to such a request, applicant relevant information will be received from the information sources. The transmitted requests will typically include at least a portion of the information obtained in step 410 and/or previously obtained applicant relevant information from this step. Typical examples of applicant relevant information that information sources may provide are: motor vehicle reports, address verification, prior loss history, verification of VIN and credit reports. Such applicant relevant information may, in some embodiments, be stored in a data store in a record associated with the applicant.

Information source data such as addressing and access parameters associated with the one or more information sources may be stored in an information source data store either separate from, or part of, an overall system data store. Establishing contact with one or more information sources may include the retrieval of such information associated with the respective information sources. The first stage in consulting such sources may be the opening of a connection to the source via a suitable communication channel as described in greater detail below. The information source data associate with a particular information source may be required to open the connection, and therefore, may be retrieved from an information source data store.

In some embodiments, only a single information source may be consulted; in others, multiple sources may be used. In embodiments using multiple sources, the sources may be contacted in a parallel or serial fashion. Where sources are contacted in a serial fashion, an information source to be contacted must be selected. The selection process may be arbitrary or based upon a specific procedure. In instances where a specific procedure is used, the process may be based upon parameters associated with the information source such as cost of access, reliability and/or amount of available information relative to the applicant, existing step 410 and/or previously obtained step 420 information associated with the applicant, alphabetical ordering of the information source names or other suitable selection or ordering process. The one or more information sources are queried to verify or confirm existing data or to provide additional data associated with or relevant to the applicant. Where multiple sources are available, all sources may, but need not be, consulted; a selected subset may be consulted. The subset selection may be based upon the existing step 410 and/or previously obtained step 420 information associated with the applicant.

In step 420, information is conveyed between the offer generation environment and one or more information sources. The conveyance of information occurs via a link, or interface, to or with a suitable communication channel for conveying the information. The link will depend upon the offer generation environment and the communication channel, or the first portion thereof where the communication channel is composed of several portions of potentially varying types. In most cases, the offer generation environment communicates information to the applicant through a processor such as a computer, which may in certain embodiments provide server functionality and be part of a server cluster; where the source of the communication is a processor, the link may be a wired or wireless modem, a serial or parallel interface, a network interface, a bus interface or combinations thereof where communication may occur via multiple communication channels or where differing types of communication occur through potentially different channels. The communication channel usually consists of one or more of the following types of channels: computer network, direct serial or parallel connection, dial-up connection, dedicated line connection, wireless connection, bus connection and combinations thereof. The communication channel may further consist of a variety of computer network types including an Ethernet, a token ring network, the Internet and/or combinations thereof. Communication may use any suitable protocol; however, in most instances, the protocol selected will depend upon the communication channel. Typically, the protocol is one or more of the following protocols alone, or in combination where multiple types of channels form portions of the communication channel: HTTP, HTTPS, SMTP, FTP, BLUETOOTH, GOPHER, interprocess communication and WAIS. This communication channel may, in some embodiments, be the same as used for communication with the applicant.

In some embodiments, the step 410 and step 420 information may be aggregated together, and potentially stored in a data store. The following is a non-exhaustive list of the types of information collected, retrieved and or verified through steps 410 and 420 that may impact the offer that is ultimately generated:

Applicant's driving history: If the applicant does not have traffic related convictions and has not been involved in an accident that was determined to be his fault, the applicant will probably pay less for his auto insurance. Companies can offer lower rates to people without traffic violations and accidents because, statistically, these drivers have a lower chance of incurring another incident.

Applicant's car: Certain cars cost more to insure for different reasons. Some cars cost a lot to repair, some cause more damage to other cars in an accident, and some are more likely to be stolen. Owning a car that fits into one of these categories can mean higher collision and comprehensive premiums. Some broad types of cars that typically cost more to insure are sports cars and SUV's.

Where applicant live: The risk of accidents, thefts, and vandalism vary significantly from one place to another. For instance, people living in small towns have generally been found to have fewer auto accidents than people living in large cities. Therefore, people in small cities usually pay less for insurance. Another reason rates may vary by where the applicant lives is the possibility of natural disaster. The risk of damage to applicant's vehicle due to a natural disaster or severe weather varies significantly from one region to another. Other variables include local auto repair prices.

Marital status: Statistically, married drivers have fewer accidents than single drivers, so they generally pay lower premiums. This is particularly true for younger drivers.

Age: Typically drivers under age 25 have more accidents than older drivers, so they pay higher premiums. Drivers between 50 and 65 years of age usually have the lowest accident rates and typically pay the lowest premiums.

Gender: Men under the age of 25 are involved in more accidents than women under the age of 25 and have more than three times as many fatal accidents. Therefore, young men incur higher premiums than young women do.

Applicable discounts: Factors such as having multiple cars on a policy, anti-theft devices, being a homeowner or having another affiliated account (such as a credit card via an affiliate of the insurer) can improve the applicant's rate by making him eligible for significant discounts. In fact, even opting to have forms e-mailed to him rather than traditional delivery via mail may result in a discount to his auto insurance.

Financial responsibility: Applicant's rate is also partially based on his credit history. Extensive industry analysis has determined customers' credit histories are highly related to their driving patterns.

In step 430, an offer of insurance is generated based at least upon the applicant relevant information from step 420. In some embodiments, the generated offer may be based upon the information obtained in step 410 in addition to, or instead of, the step 420 information. In embodiments where the 410 and 420 information is aggregated, the offer is generated based at least in part upon the aggregated applicant information. Embodiments of the present invention will use traditional, industry standard rating and underwriting principles to generated the offer; however, this process occurs in real-time during the application process rather than during a prior art “free-look” period. An offer generation may typically include the following steps: (a) determining an underwriting tier for the applicant based upon the step 410 and/or 420 information, (b) retrieving a base rate based upon the determined underwriting tier, and (c) calculating the rate component based upon the base rate and the step 410 and/or 420 information. In some such embodiments, the generated offer may be modified based upon dynamic pricing principles as further detailed below or available discounts. In other embodiments, a dynamic pricing approach may be integrated into the offer generation process rather than result in a modification to a traditionally generated offer.

In some embodiments, the generated offer may be stored for subsequent retrieval in a data store in a record associated with the applicant. In some of these embodiments, a determination may be made as to whether such a previously stored offer associated with the applicant exists. If so, a new offer is not generated from scratch, but this step retrieves the previously stored offer and uses it as the generated offer. Stored offers may also be subject to a validity check prior to reuse. A variety of factors may be used to determine validity; these factors may include age of offer, change in applicant information change in dynamic pricing factors, change in state laws and/or rates, change in special offers and combinations thereof.

The generated offer in some embodiments may include a rate component, a fee component and/or an incentive component. A rate component to the offer may be generated based upon the desired coverage types and amounts and the applicant's risk factors. The fee component may be based upon a variety of factors including processing fees for processing the application, service charges for deferred payment plans and fee for recovering costs paid to information sources to collect and/or verify data associated with the applicant. In some embodiments using rate and fee components, these components may be balanced within the overall generated offer based upon step 410 and/or 420 information associated with the applicant. Some embodiments may also use an incentive component where an incentive is included in the generated offer. Typically, the following types of incentives may be included: a discount on the offered insurance product, a discount on a third party product or service, an award in a third-party incentive program, and a free third party product or service. Rebates may also be used in jurisdiction where rebates are legal in the context of insurance sales. The processes used to generate any of these components may use either a dynamic pricing modifier or a generation process integrating dynamic pricing as further detailed below.

In step 440, the generated offer is presented to the applicant. Typically, this will occur as a result of the offer being transmitted to an output device associated with the applicant. In most instances, the output device will be a computer, a telephone, a facsimile machine or some combinations thereof, however, any suitable output device for conveying the offer to the applicant may be used within the scope of the present invention. Where the output device is a computer, the computer will typically use a monitor as a display device; however, the display device may also be a speaker or other audio display, a tactile display, a printer or other print display, combinations of these or combinations of these along with a monitor. This output device may be the same as, or different from, the output device as described above for requesting information from the applicant and/or described below for delivering the issued policy.

In step 450, an acceptance signal is received, or inferred. An explicit acceptance may be received in response to some action by the applicant using an input device. Such an action could be using a mouse or keyboard to trigger transmission of an acceptance signal from a user computer associated used by the applicant, voicing a response or keying a tone on a telephone in an automated voice response system, sending an acceptance by email to an automated email processing system or other suitable trigger as would be known to one of skill in the art. An acceptance may also be inferred from an applicant's actions. One such action could be the transmission of sufficient payment information to cover the cost in the presented offer. Alternatively, such payment information may be transmitted as part of, or in addition to, an explicit acceptance.

Payment information may be of an immediate or deferred nature. Payment information of an immediate nature may be of a variety of types including charge card, debit card, direct bank account withdrawal, electronic fund transfer and combinations thereof. If the payment type is of an immediate nature, it may, in some embodiments, be directly processed in real-time so as to allow the insurer to derive compensation thereby. Payment of a deferred nature may include a request to be billed by mail or through periodic installments either by mail or automatically using one of the immediate payment types. In embodiments allowing submission of payment information of a deferred natured, the sufficiency of such information may depend upon a rating of the applicant's credit.

In step 460, a policy is generated. The generated policy will be based at least upon the generated offer, and may also be further based upon the information from steps 410 and/or 420. In some embodiments, a policy template may be selected based upon the applicant's state of residence; this policy template may then be modified in accordance with the generated offer and the step 410 and/or step 420 information.

In step 470, a policy drawn in accordance with the generated offer from step 460 is delivered the applicant. Delivery of the policy may be via any suitable delivery vehicle including electronic deliver via a policy output device or physical delivery via mail or courier service. In most instances of electronic delivery, the output device will be a computer; however, any suitable output device such as a facsimile for delivering the policy to the applicant may be used within the scope of the present invention. Where the output device is a computer, the computer will typically use a monitor as a display device; however, the display device may also be a speaker or other audio display, a tactile display, a printer or other print display, combinations of these or combinations of these along with a monitor. This output device may be the same as, or different from, the output device as described above for requesting information from the applicant and/or for presenting the generated offer.

In a variety of instances described above including requesting and receiving information, presenting the offer, receiving an acceptance signal and/or payment information and delivering the policy, information is conveyed to the applicant. The conveyance of information to the applicant occurs via a link, or interface, to or with a suitable communication channel for conveying the information. The link will depend upon the offer generation environment and the communication channel, or the first portion thereof where the communication channel is composed of several portions of potentially varying types. In most cases, the offer generation environment communicates information to the applicant through a processor such as a computer, which may in certain embodiments provide server functionality and be part of a server cluster; where the source of the communication is a processor, the link may be a wired or wireless modem, a serial or parallel interface, a network interface, a bus interface or combinations thereof where communication may occur via multiple communication channels or where differing types of communication occur through potentially different channels. The communication channel usually consists of one or more of the following types of channels: computer network, direct serial or parallel connection, dial-up connection, dedicated line connection, wireless connection, bus connection and combinations thereof. The communication channel may further consist of a variety of computer network types including an Ethernet, a token ring network, the Internet and/or combinations thereof. Communication may use any suitable protocol; however, in most instances, the protocol selected will depend upon the communication channel. Typically, the protocol is one or more of the following protocols alone, or in combination where multiple types of channels form portions of the communication channel: HTTP, HTTPS, SMTP, FTP, BLUETOOTH, GOPHER, interprocess communication and WAIS. This communication channel may, in some embodiments, be the same as used for communication with the one or more information sources.

As mentioned above, some embodiments may use dynamic pricing principles to better tailor the generated offer. These dynamic pricing principles may be used in a variety of ways to adjust or generate the offer as described herein. The following discussion described this use with respect to the rate component of the offer; however, the modification of other offer components through dynamic pricing principles is within the scope of the present invention. Those of skill in the art will readily appreciate that the same approach using the same, or other factors, may be used with other portions of the offer, in embodiments where the offer constitutes multiple portions, including, without limitation, a fee component and/or a purchase incentive component.

In some dynamic pricing embodiments, a typical process occurs to generate the rate component of the offer; namely, the rate is calculated from a retrieved base rate determined by the applicant's underwriting tier as determined based upon applicant specific information such as obtained in steps 410 and/or 420 in FIG. 4, and potentially modified based upon other applicant specific information. Such embodiments may involve deriving an adjustment to the retrieved base rate based at least in part upon applicant specific information and a dynamic pricing factor based upon analysis of analytic information selected from the group consisting of demand level, cost, return on assets and combinations thereof. Once the dynamic pricing adjustment is derived, it can be applied to a traditionally generated rate to calculate the final rate component.

The analysis of the analytic information may occur in real-time and generate the dynamic pricing factor as each offer is generated. In other embodiments, the analysis may occur at periodic intervals, such as hourly, nightly or weekly batch processing. Where analysis occurs on a periodic basis, the results of the analysis may be stored in a dynamic pricing factors table. The current table would be used to generate any offers to be made until the generation of a new table. In such embodiments, the appropriate factor can be retrieved from the table and applied as required. The real-time generation of a dynamic pricing factor can be viewed as a particular case of the periodic generation method, where the period approaches zero; a new table would be available for each offer generated. In some particular embodiments where the analytic information includes demand level, conversion rates may be used as an indicator of demand level. The adjustment table generation may include analyzing conversion rates for previous purchases of insurance products; forecasting conversion rates for potential further purchases based upon the analyzed conversion rates and preparing the adjustment table based at least in part upon the is analyzed and forecasted conversion rates. The discussion below provided greater detail regarding dynamic pricing calculation and factor table generation.

In other dynamic pricing embodiments, pricing tiers calculated according to dynamic pricing principles may be used rather than a traditional determination of the underwriting tiers to generate the base rate. These embodiments use a process fairly similar to the one described above with respect to determining a modifier to a traditionally derived rate, fee or purchase incentive components. Under this approach, the base rate, fee or purchase incentive is worked into the tiers at the outset. As a consequence, the appropriate component calculation does not require an additional dynamic pricing adjustment. An offer generation may typically include the following steps: (a) determining a pricing tier for the applicant based upon the step 410 and/or 420 information and a dynamic pricing factor based upon analysis of analytic information selected from the group consisting of demand level, cost, return on assets and combinations thereof, (b) retrieving a base rate based upon the determined pricing tier, and (c) calculating the rate component based upon the base rate and the step 410 and/or 420 information. This may be accomplished through applying traditional base rates to a dynamic pricing adjustment table as described above. Generation of the appropriate offer component becomes a retrieval of the appropriate base rate, fee and/or purchase incentive from the table.

In yet another set of dynamic pricing embodiments, state regulatory practice may require an alternative approach to the incorporation of dynamic pricing principles. In these embodiments, the offer components being calculated is performed as in an environment without dynamic pricing; however, the initial selection of a company to provide the offer is based upon the dynamic pricing strategy. In these embodiments, an offering company is selected from a set of available offering companies based upon applicant specific information, such as obtained via steps 410 and/or 420 above, and a dynamic pricing factor based upon analysis of analytic information selected from the group consisting of demand level, cost, return on assets and combinations thereof. Once an offering company has been chosen, an underwriting tier from the offering company is chosen for the applicant based upon applicant specific information. A base rate is retrieved based upon the determined underwriting tier and the rate component is calculated based upon the base rate and the applicant specific information. At some point, identification information associated with the offering company is added to the offer.

The determination of the offering company may be based upon the procedures described above with respect to determining a dynamic pricing modifier. Namely, an offering company table can be generated according to dynamic pricing principles as described above. As above, table generation could be real-time based upon demand or could occur at periodic intervals. The table would be indexed based upon applicant specific information to retrieve an offering company. The offering company would then perform a typical process for generating the offer. The dynamic pricing principles would be incorporated at the stage of initially selecting the company to provide the applicant with the offer.

The following discussion outlines the approach that may be taken in some embodiments to generate the tables for dynamic pricing factors, pricing tier selection and offering company selection as outlined above.

Dynamic Pricing Support Environment

This section provides a brief description of a typical environment to support the dynamic pricing as discussed above. There are two key concepts that are central to this dynamic pricing system implementation:

1. Pricing tiers: Traditional rate filings specify a single base rate level for a particular coverage type. For example, BI (bodily injury) coverage could have a base rate of $75 for a six-month term. This rate is then modified by risk factors, called relativities, specific to an individual to arrive at a final rate. Currently, all BI policies in a particular state derive their rate from this single base rate. Dynamic pricing selects one of several base rates to generate a rate for a single coverage type for an individual customer. A collection of base rates, one for each coverage type, is called a pricing tier. For example:

Pricing tier 1 BI=$84, PD=$111, and so on for the other coverage types

Pricing tier 2 BI=$75, PD=$102

Pricing tier 3 BI=$67, PD=$90

The differentials between pricing tiers may be represented by percentage changes from a base tier, in much the same way relativities are represented in rate manuals.

2. Pricing Segments: Dynamic pricing assigns customers to pricing tiers based on values of dynamic pricing variables derived from applicant information. A pricing segment is a collection of existing and potential customers that share common values for the pricing variables. Any individual requesting an offer for insurance belongs to one, and only one, pricing segment based on their characteristics. For example, home ownership and days prior to expiration of current policy could be used as segmenting variables with the following values:

Home ownership is a Boolean with values yes or no.

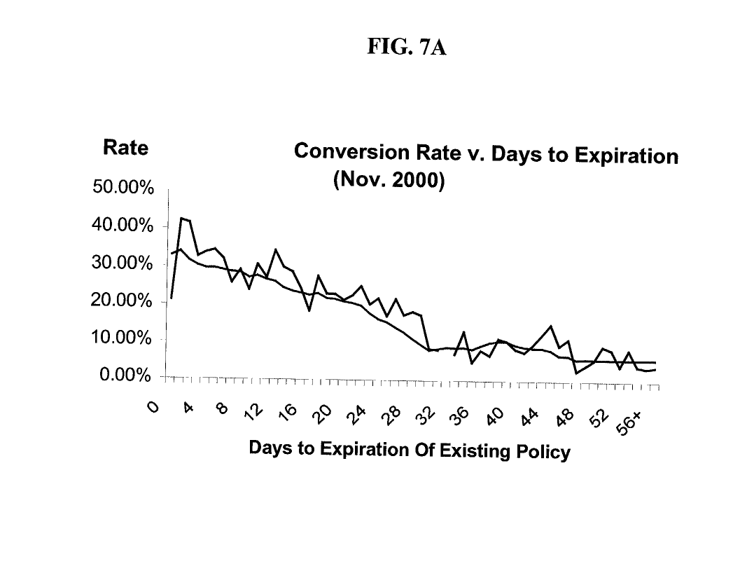

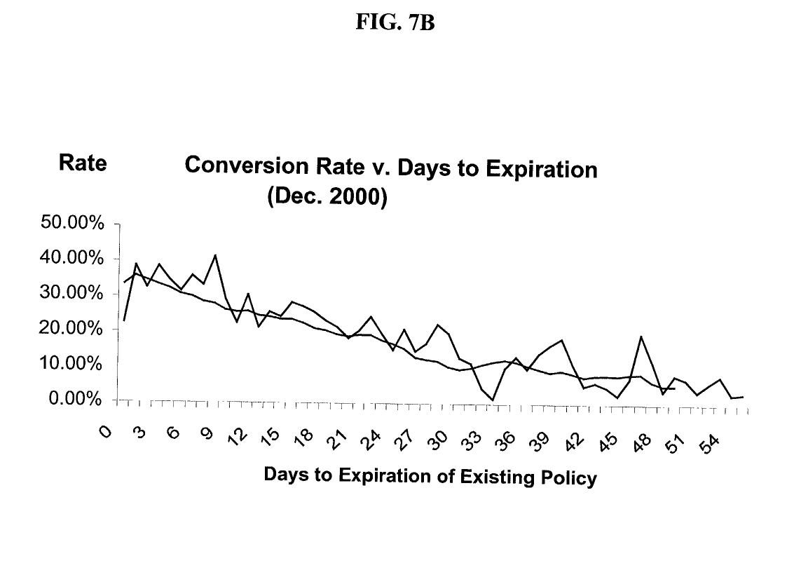

Days prior to expiration is a continuous variable that is divided into three categories: greater than 21 days, between 21 and 7 days, and within 7 days. This variable may be extremely pertinent based upon analysis of conversion rate data with respect to time until expiration. The graphs seen in FIGS. 7A and 7B depict this relationship for the months of November and December of 2000 and highlight the potential correlation between expiration date and conversion rate.

In this example, there are six pricing segments as follows:

| Price Segment | Home Owner | Days to Expiration Category |
|---|---|---|
| 1 | Y | 0-7 |
| 2 | Y | 8-21 |
| 3 | Y | 21+ |
| 4 | N | 0-7 |
| 5 | N | 8-21 |
| 6 | N | 21+ |

Those of skill in the art will appreciate that other variables may be used to segment the applicant population. Segmenting for dynamic pricing may use cost and/or return on assets as well as, or instead of, demand level. Other types of variables that might be used include:

Behavior Variables may be derived from information about customer behavior available from interaction at the time of a request for an offer of insurance. For example, Click through from is a variable that refers to the web-site that a customer was viewing immediately prior to the offer generation environment. In many cases the click-through will occur as a result of promotional activity on the originating Web site. The ‘Click through from’ data contains some implicit customer characteristic information that can be discovered by analyzing aggregate customer behavior based on originating Web site. Discounting rules may also be applied in certain embodiments based upon the originating Web site.

Rating variables are used to identify the risk and potential magnitude of administrative, operational, and claims costs associated with offering insurance to the individual customer. These costs are represented by relativity factors, which are used to modify base rates as part of the rate generation process. Dynamic pricing provides a mechanism to correct for inaccurate or outdated loss cost assessments prior to filing updated relativities with the appropriate Department of Insurance. Dynamic pricing also tracks demand behavior associated with traditional rating variables. Type of Vehicle is a traditional rating variable that carries customer characteristic information.

Other Cost Variables Other cost variables are less precisely related to the individual characteristic. Opportunity cost reflects the attractiveness of the policy as a means of producing investment income. Exposure is a cost variable that reflects the impact of customer characteristics on portfolio mix.

The dynamic pricing system may track and forecast demand segmented by the values of each of these variables individually. Each pricing segment is associated with a single pricing tier or dynamic pricing adjustment factor. In practice the dynamic pricing system will support pricing segments defined by almost any variable available from the any applicant specific data such as would be obtained through steps 410 and/or 420 in FIG. 4. Selection and priority of these variables may be configurable for each state through any suitable configuration mechanism such as configuration files, parameters entered at execution or a dynamic pricing support environment, and may be periodically updated. This means that the definition of the pricing segments is configurable and may change. In order for dynamic pricing to work, the definition of segments must be comprehensive and mutually exclusive with respect to membership of a segment by an individual applicant or policy holder.

When a customer requests an offer for insurance, they provide the information needed to figure out to which pricing segment they belong. At any given time, the pricing segment may be assigned to a particular pricing tier. The customer's rate is computed based on the base rates or dynamic pricing adjust factor associated with the assigned pricing tier. Over time these assignments may change, so that the same customer could get a different rate if they re-requested the offer. Rate filing is not necessary to make the assignment changes.

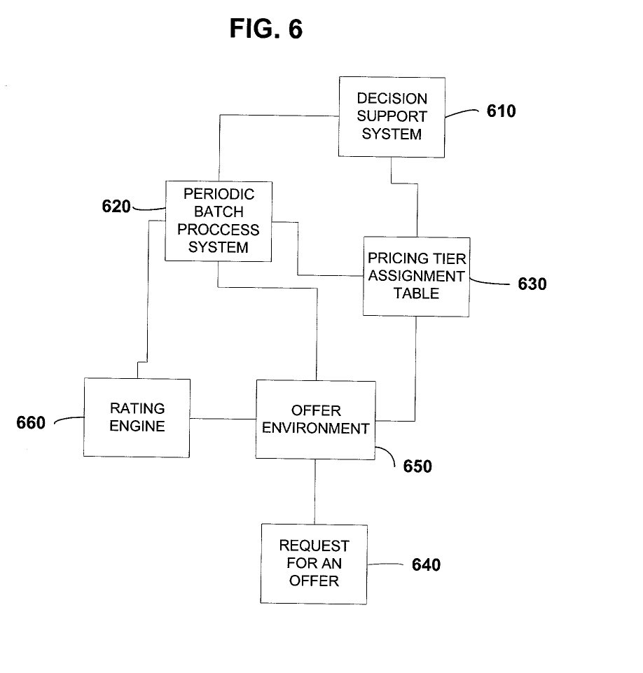

A typical dynamic pricing environment may include the following three major software components. These components and their interactions are seen graphically in FIG. 6.

1. The Pricing Tier Assignment Table 630 is stored and managed by an online system. Each time an offer is requested 640 from an offer environment 650, a lookup is performed against this table to determine which pricing tier or dynamic pricing adjustment factor should be used to compute a rate for the offer. This information, together with values for rating variables derived from the applicant information is sent to the rating engine 660. The rating engine returns a rate for the individual request for offer of insurance.

2. The Dynamic Pricing Batch Process 620 generates pricing tier assignment change recommendations based on changes in customer demand and consumption behavior as provided by the offer environment 650. Input as to the currently rates in force, derived from the rating engine 660, is also used in this process. Further, the pricing tier assignment table 630 is updated, potentially subject to review via a decision support system 610.

3. The Dynamic Pricing Decision Support System 610 provides a product manager with tools to evaluate rate recommendations from the batch process 620 and make changes to the pricing tier assignment table 630.

Since the regulatory environment is different in each state, the dynamic pricing features of each rate filing will be different. The objective of each filing is to create a set of pricing tiers that implement different base rate levels. The major differences in dynamic pricing filing types will be:

Underwriting Tiers—In states that do not require filing of underwriting tier information multiple dynamic pricing related tiers at various rate levels can be defined. Rates from these tiers can be made available for sale or made unavailable based on business needs.

Product Differentiation—Some states will be amenable to rate variation based on different product definitions. For example, several different coverage amounts may be available for any given policy. Each coverage amount will correspond to a different pricing tier.

Separate Companies—In states where underwriting tier and product differentiation strategies do not meet regulatory requirements, it will be necessary to establish separate companies, probably with different cost structures that justify different base rates.

The Online Pricing Tier Assignment Table

The system of record for the assignment of pricing segments to pricing tiers is typically an online offer generation system as described in greater detail above. It is responsible for the storage, maintenance, backup and recovery, dissemination, and update of the pricing tier assignment table. It also uses this table in each request for offer that it sends to the rating engine. As part of any request for offer that is sent to the rating engine, the pricing tier will be indicated. The online environment will derive the pricing tier assignment, from a lookup against the pricing tier assignment table.

Continuing the example above with two price segmenting variables, home ownership and days prior to expiration, the Pricing Tier Assignment Table may in some embodiments contain the following fields:

| | |
|---|---|
| State | A two character identifier representing the regional |
| | political sub-entities of the United States. |
| Price Segment | An index that uniquely identifies a combination of |
| | underwriting tier and territory within a state. |
| Home ownership | One of {y, n} |
| Days Prior | One of {early, middle, late} corresponding to |
| | categories: greater than 21 days, between 21 and |
| | 7 days, and within 7 days. |
| Index | The pricing tier index, which uniquely identifies a |
| | price tier that has been filed in the state. |

| For example: | | | | | |
|---|---|---|---|---|---|
| | | Price | Home | Days | Pricing |
| | State | Segment | Owner | Prior | Tier |
| | TX | 1 | Y | Early | 5 |
| | TX | 2 | Y | Middle | 5 |
| | TX | 3 | Y | Late | 5 |
| | TX | 4 | N | Early | 5 |
| | TX | 5 | N | Middle | 5 |
| | TX | 6 | N | Late | 5 |

The Rating Engine

The offer environment generates offer requests and policy creation transactions that are passed to the rating engine. Transactions that contain a request for offer will also contain information that allows the rating engine to generate a rate for the specific request. In some embodiments, the offer environment provides the pricing tier index as part of that information set. The offer environment may derive the pricing tier index by a lookup function that compares the State, Home Ownership, and Days Prior in the request for offer information to the same fields in the pricing tier assignment table.

The rating engine will use the pricing tier index to select base rates from a matrix of base rates, or an equivalent representation, that will be provided as part of the filing process for any dynamic pricing rate filing. Dynamic pricing filings will have the following common features:

The same relativity values will be filed for all pricing tiers.

Pricing tiers will have different base rates.

For example

| | | | | | UIM | | | | | |
|---|---|---|---|---|---|---|---|---|---|---|
| Price Tier | BI | PD | MP | UMBI | BI | UMPD | Comp | RR | T & L | Coll |
| 1 | 126.41 | 149.51 | 49.84 | 40.11 | 13.37 | 25.53 | 102.10 | 36.47 | 7.29 | 420.57 |
| 2 | 120.39 | 142.39 | 47.46 | 38.20 | 12.73 | 24.31 | 97.24 | 34.73 | 6.95 | 400.54 |
| 3 | 114.66 | 135.61 | 45.20 | 36.38 | 12.13 | 23.15 | 92.61 | 33.08 | 6.62 | 381.47 |
| 4 | 109.20 | 129.15 | 43.05 | 34.65 | 11.55 | 22.05 | 88.20 | 31.50 | 6.30 | 363.30 |
| 5 | 104.00 | 123.00 | 41.00 | 33.00 | 11.00 | 21.00 | 84.00 | 30.00 | 6.00 | 346.00 |
| 6 | 99.05 | 117.14 | 39.05 | 31.43 | 10.48 | 20.00 | 80.00 | 28.57 | 5.71 | 329.52 |
| 7 | 94.33 | 111.56 | 37.19 | 29.93 | 9.98 | 19.05 | 76.19 | 27.21 | 5.44 | 313.83 |
| 8 | 89.84 | 106.25 | 35.42 | 28.51 | 9.50 | 18.14 | 72.56 | 25.92 | 5.18 | 298.89 |
| 9 | 85.56 | 101.19 | 33.73 | 27.15 | 9.05 | 17.28 | 69.11 | 24.68 | 4.94 | 284.66 |

Base rates are unique by coverage type for any given filing within a single state in non-dynamic pricing environments. With dynamic pricing, base rates are unique by coverage type and pricing tier index. In the table above, if a request for offer is generated for BI and PD and the pricing tier index that offer environment passes is 5, then the base rate used for BI is $104 and the base rate used for PD is $123.

Pricing Tier Index by Underwriting Tier

If the rate filing in a particular state uses pricing tier index to indicate a specific underwriting tier then the underwriting tiers defined by the financial responsibility related tiers

{UPP, UP, PP, P, SP, S, I, MM, B, N}

are further subdivided into a detailed underwriting tier. For example, 10 financial responsibility tiers combined with 9 price program indices result in 90 base rates per coverage type.

| Tier | Tier Variable | Pricing Tier Index | BI | PD . . . |
|---|---|---|---|---|
| 1 | UPP | 1 | 126.41 | |
| 2 | UPP | 2 | 122.00 | |
| 3 | UPP | 3 | | |
| . . . | | | | |
| 9 | UPP | 9 | | |
| 10 | UP | 1 | | |
| 11 | UP | 2 | | |
| . . . | | | | |
| 90 | N | 9 | 154.55 | |

Pricing Tier Index by Product

If the rate filing in a particular state uses product differentiation to implement pricing tier indices, then differences in product definition may be indicated by the pricing tier index that may not be explicitly identified by the request for offer. Three different coverage amounts may be available for any given policy. Each coverage amount will correspond to a different base rate.

| Price Tier | Coverage Type | Coverage Amount | Base Rate |
|---|---|---|---|
| 1 | BI | 50,002 | 170 |
| 2 | BI | 50,001 | 140 |
| 3 | BI | 50,000 | 120 |

The request for quote from the offer environment may specify a coverage amount of 50,000 for BI but provide a pricing tier index of 2, which according to the rate filing offers a coverage amount of 50,001. The Rating engine needs to know that the trivial difference in coverage is subordinate to the need to match price tier. However, the rating engine must also be able to differentiate substantial differences in coverage amount. A request for $75,000 coverage amount should not be rated at the 50,002 level in order to match with a request for pricing tier 1. It could be that the rating engine contains an approximation factor for coverage amount that allows roughly equivalent coverage amounts to be treated as equal. Alternatively, the offer environment could provide additional information to the rating engine to support the pricing tier assignment logic.

Pricing Tier Index by Separate Companies

Multiple companies may be licensed to do business in a particular state, but for a given risk at a given point in time, only one company is offering insurance. Each company will correspond to a different base rate for each coverage type.

| Price Tier | Company Name | BI Base Rate | PD Base Rate |
|---|---|---|---|
| 1 | GMAC Premier | 170 | 78 |
| 2 | GMAC Quality | 140 | 49 |
| 3 | GMAC Value | 120 | 38 |

The request for quote from the offer environment may specify a pricing tier index, which indicates which company the offer should be selected from.

The Dynamic Pricing Batch Process

The dynamic pricing batch process runs on a periodic basis, or in real-time in some embodiments, to generate rate change recommendations based on changes in customer demand and consumption behavior. Typically, the batch process will run daily; however, the process may be run more or less frequently in other embodiments. The input to this process is the most recent observations of sales pace and conversion rate by segmenting variable. The output is the price tier assignment that maximizes expected premium system-wide. The batch process can be broken into the following steps:

1. Update Demand Response Curve

2. Update Full/Liability Mix

3. Forecast Offers

4. Forecast Conversion Rate

5. Expected Premium

6. Expected Premiums for Other Price Tiers

7. Rate Optimization

It is possible to implement some of these components independently from others. For example in some embodiments, supporting dynamic pricing involves deriving a rate change direction based on forecast and observed conversion rates (i.e., item 4 above) and foregoes rate optimization in favor of incremental rate adjustments. In some such embodiments, when observed conversion rate levels are significantly higher than forecasted conversion rates for a particular segment, an increase in rate equivalent to assigning the price segment to the next higher price tier will be recommended by the environment, and when observed conversion rate levels are significantly lower than forecasted conversion rates for a particular segment, a decrease in rate equivalent to assigning the price segment to the next lower price tier will be recommended by the environment.

Demand Response Curve

For each price variable the dynamic pricing system maintains a demand response curve. The demand response curve describes the percentage change in demand, i.e. demand for written policies, for the percentage change in base rate represented by each price tier. The demand response curve is initialized by regression analysis on analytic information. The first step in the nightly batch process is to update the demand response curve with the latest information available.

For example, a demand response curve for a dynamic pricing environment with three price tiers would have three values. Suppose the variable we are concerned about is pointed at price tier number two:

| Price Tier | Price Difference | % Demand Change |
|---|---|---|
| 1 | 5% | −10% |
| 2 | 0% | 0% |
| 3 | −5% | 10% |

What this says is that an extra 10% demand can be stimulated if the rate is cut by 5%, or an extra 5% premium per policy could be obtained at the expense of 10% of the demand.

As part of the batch process, the actual demand that was realized for a particular price segment is reviewed. If the amount of demand obtained differs from expectation, current expectations need to be revised. Suppose current expectation is 90 policies in the previous month, but 100 were obtained. Most of the 10% demand increase that the current demand curve indicates is available was obtained, but without a price cut. Therefore, the following table may be considered more accurate.

| Price Tier | Price Difference | % Demand Change |
|---|---|---|
| 1 | 5% | −20% |
| 2 | 0% | 0% |
| 3 | −5% | 20% |

In reality, the new results are blended into the prior expectation so that they are accounted for but do not dramatically change the table values for each observation. A smoothed table may look more like this:

| Price Tier | Price Difference | % Demand Change |
|---|---|---|
| 1 | 5% | −11% |
| 2 | 0% | 0% |
| 3 | −5% | 11% |

Alternatively, user defined demand response curves can be used. The decision support system as described below may allow the product manager to specify the slope and intercepts of the demand response curve at any level of aggregation, as well as degrees of confidence for accepting system generated curves. The product manager may also develop business rules that specify the curve. For example the product manager may want the average to stay below the high priced competition 90% of the time but be above low priced competition 85% of the time for the median price tier. The system will use the most recent competitive information it has to create the demand response curve that is constrained by these parameters.

Update Full/Liability Mix

Demand changes in response to rate changes in two ways. The number of policies written will change and the relative number of different types of policy will also change. The batch process will monitor the mix of liability only and full coverage policies in different price tiers and adjust the expected premium generation to account for the change in mix. For a three tier dynamic pricing environment this mix table could look like the following:

| Price Tier | Liability Only | Full Coverage |
|---|---|---|
| 1 | 20% | 80% |
| 2 | 25% | 75% |
| 3 | 35% | 65% |

Of course, if Full/Liability only are chosen to be one of the segmenting variables this table will not be necessary.

Forecast Offers

Based on the most recent history of offer activity a forecast of the number of offers for each price segment is generated for the next 30 days in the future. It is assumed that the number of requests for offer for each price segment is independent of the rate. It will be generated by a time-series forecast that will capture trend and seasonality and causal factors such as promotional activity, if the price analyst tells the system about this activity.

Forecasting Conversion Rate

The customer will respond to offers of insurance from the offer environment in three primary ways. They will accept the offer at once, they will accept the offer at a later point in time, or they will reject the offer. Because of this an accurate picture of conversion rate will not be available until 30 days past the offer date, which is how long an offer remains good. In order to adjust rates with the most recent information available conversion rates need to be forecasted.

The conversion forecast will apply to offers still outstanding from the past 30 days and offers expected to come in the next 30 days. Therefore, this process can forecast conversion activity up to 60 days in the future. This conversion rate forecast assumes the current price tier assignments are not changed.

The following table illustrates a forecasting methodology that capitalizes on knowledge of historic conversion rate behavior. Each row in the table represents a date on which offers of insurance are made. Today's date in this example is Jan. 8, 2000. The numbers across the top represent the number of days past the offer date that policies were written. The values in these columns are the number of policies that were written. So on 4 days after Jan. 2, 2000, which is Jan. 6, 2000 there were 4 policies written arising from offers made on Jan. 2, 2000. The total number of offers made on Jan. 2, 2000 was 78.

The bold numbers represent actual observed values. Since it is Jan. 8, 2000, the number of polices that converted for Jan. 7, 2000 on that day is known, but no other information. For Jan. 4, 2000, real information is available for 1, 2, 3, and 4 days past, which leads to Jan. 7, 2000 but not to Jan. 8, 2000 for which results will not be known until the end of the day.

| | | | | | | | | | | Expected |
|---|---|---|---|---|---|---|---|---|---|---|
| Offer | | | | | | | | Total | Total | Conversion |
| Date | 6 | 5 | 4 | 3 | 2 | 1 | 0 | Offers | Policies | Rate |
| 1/1/00 | 3 | 4 | 2 | 4 | 6 | 1 | 1 | 97 | 21.00 | 22% |
| 1/2/00 | 2.41 | 3 | 4 | 2 | 3 | 2 | 4 | 78 | 20.41 | 26% |
| 1/3/00 | 3.22 | 4.14 | 3 | 0 | 4 | 3 | 3 | 104 | 20.36 | 20% |
| 1/4/00 | 2.69 | 3.47 | 2.92 | 4 | 1 | 0 | 2 | 87 | 16.08 | 18% |
| 1/5/00 | 2.07 | 2.67 | 2.25 | 1.89 | 2 | 1 | 0 | 67 | 11.88 | 18% |
| 1/6/00 | 3.37 | 4.34 | 3.66 | 3.08 | 3.93 | 2 | 0 | 109 | 20.38 | 19% |
| 1/7/00 | 3.06 | 3.95 | 3.32 | 2.79 | 3.57 | 1.62 | 1 | 99 | 19.31 | 20% |
| 1/8/00 | 2.83 | 3.65 | 3.08 | 2.58 | 3.30 | 1.50 | 1.62 | 91.57 | 18.55 | 20% |
| 1/9/00 | 2.83 | 3.65 | 3.08 | 2.58 | 3.30 | 1.50 | 1.62 | 91.57 | 18.55 | 20% |
| 1/10/00 | 2.83 | 3.65 | 3.08 | 2.58 | 3.30 | 1.50 | 1.62 | 91.57 | 18.55 | 20% |
| 1/11/00 | 2.83 | 3.65 | 3.08 | 2.58 | 3.30 | 1.50 | 1.62 | 91.57 | 18.55 | 20% |
| 1/12/00 | 2.83 | 3.65 | 3.08 | 2.58 | 3.30 | 1.50 | 1.62 | 91.57 | 18.55 | 20% |
| 1/13/00 | 2.83 | 3.65 | 3.08 | 2.58 | 3.30 | 1.50 | 1.62 | 91.57 | 18.55 | 20% |

The non-bold numbers with 2 decimal places displayed are forecasts. They are derived as follows. For each offer date and days past pair, we divide the number of policies by the total number of offers for the offer date to get an observed conversion rate. This is stored in the next table below. An average of all conversion rates for each days past is taken to get a typical conversion rate for each days past. This days past conversion rate is multiplied by the offers for each day in history to get an expected number of policies. For days in the future the average total number of offers is used to forecast these days, and then, the average days past conversion rate is used to fill in the rest of the table. The sum of the numbers in each row gives the total number of policies that are expected to be written and, therefore, are used to compute the expected conversion rate for each offer day.

| Offer Date | 6 | 5 | 4 | 3 | 2 | 1 | 0 |
|---|---|---|---|---|---|---|---|
| 1/1/00 | 3% | 4% | 2% | 4% | 6% | 1% | 1% |
| 1/2/00 | | 4% | 5% | 3% | 4% | 3% | 5% |
| 1/3/00 | | | 3% | 0% | 4% | 3% | 3% |
| 1/4/00 | | | | 5% | 1% | 0% | 2% |
| 1/5/00 | | | | | 3% | 1% | 0% |
| 1/6/00 | | | | | | 2% | 0% |
| 1/7/00 | | | | | | | 1% |
| | 3% | 4% | 3% | 3% | 4% | 2% | 2% |

In practice the table will span 30 days past, sufficient history to get good forecasts and enough future days to support the needs of the rate optimization engine.

Expected Premium

Expected premium is calculated for each of the price segments for the current price tier assignment. The forecast of offers is multiplied by the conversion rate forecast to get the number of policies that are expected to be written in the next 30 days. These are proportioned into Full and Liability only coverage and multiplied by the observed average premium in each to get an expected dollar amount for the next 30 days for each price segment. The following example illustrates this calculation for price tier 2, the current tier

| | |
|---|---|
| Average Premium for full coverage | $1,200 |
| Average Premium for liability only | $500 |
| Expected Offers | 1,000 |
| Conversion rate | 3% |
| Liability | 25% |
| Full Coverage | 75% |

| | |
|---|---|
| Expected Premium = | (.75 * 1,200 + .25 * 500) .03 * 1,000 = |
| | $30,750 |

Expected Premiums for Other Price Tiers

Expected written premium for each price tier is computed by adjusting the forecast conversion rate by a factor derived from the demand response curve. Demand for full and liability coverage is adjusted based on the mix measures for that price tier. The average premiums are multiplied by the expected demand to get total expected premiums for the next 30 days. This adjusts the demand and average rate to get values for the other price tiers. For example price tier 1 has the following values:

| | |
|---|---|
| Average Premium for full coverage | $1,200 * 105% = $1,260 |
| Average Premium for liability only | $500 * 105% = $525 |
| Expected Offers | 1,000 |
| Conversion rate | 3% * 89% = 2.67% |
| Liability | 20% |
| Full Coverage | 80% |

| | |
|---|---|
| Expected Premium | = (.8 * 1,260 + .2 * 525).0267 * 1,000 |
| | = $29,717 |

| Based on a demand response curve of | | |
|---|---|---|
| Price Tier | Price Difference | % Demand Change |
| 1 | 5% | −11% |
| 2 | 0% | 0% |
| 3 | −5% | 11% |

| And a Mix table of | | |
|---|---|---|
| Price Tier | Liability Only | Full Coverage |
| 1 | 25% | 75% |
| 2 | 20% | 80% |
| 3 | 65% | 35% |

| For tier 3 the expected premium is | |
|---|---|
| Expected Premium | = (.65 * 1,140 + .35 * 475).333 * 1,000 |
| | = $30,211 |

Rate Optimization

The process of rate optimization is simply to select the price tier that generates the most written premium. It also computes an estimate of the impact of making a change from the current price tier assignment to assist workflow management.

| Price tier | Premium |
|---|---|
| 1 | 29,717 |
| 2 | 30,750 |
| 3 | 30,211 |

In the example above, price tier 2 is recommended. Since that is already the assigned tier, no change is made.

Decision Support System

A dynamic pricing decision support system may, in some embodiments, provide product managers with tools to evaluate rate recommendations from the batch process and make changes to the pricing tier assignment table. In other embodiments, a decision support system may not be present, in which case the batch process results are used without review, or a decision support system allowing optional review and revision of the batch process results may be present.

In some embodiments, the decision support system may consist of the following components:

Workflow management screens provide the product manager with summary level information about demand, conversion rate, and price recommendation magnitude and quantity at a level of aggregation that allows the most effective selection of which market segments to manage first.

Recommendations management screens permit detail viewing, editing and implementation or rejection of individual pricing tier assignment actions. Each time this screen is accessed, it loads the most recent copy of the pricing tier assignment table from the offer environment for a particular state. The offer environment needs to enforce the requirement that an individual state can only be accessed by one user at a time. Once the user has completed accepting, rejecting, and editing pricing tier assignment changes a send button on the GUI implements these changes in the offer environment's version of this table.

Base rate management screens display the most recent base rates from the rating engine. Although the system may provide change recommendations for these base rates it does not provide an automated mechanism for base rate update. Instead, changes to base rates must be implemented through the existing filing procedure. Once the new base rates have been entered in the rating engine they will be available to the dynamic pricing decision support system.

Competitor monitoring screens compute in real-time and display competitor rates for selected risks.

Reports are provided by the decision support system to support rate management activities.

System administration and file maintenance screens will display and allow authorized users to edit all data and parameters in the decision support system.

In one specific embodiment, the decision support system may use Microsoft Access as the implementation platform with data imported as needed from the offer environment, the rating engine and the periodic batch process system.

Throughout this application, various publications may have been referenced. The disclosures of these publications in their entireties are hereby incorporated by reference into this application in order to more fully describe the state of the art to which this invention pertains.

The embodiments described above are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A method of providing an offer of insurance for an applicant in real-time using an automated offer generation system, the method comprising the steps of:
a) receiving applicant specified information associated with the applicant;
b) establishing an initial connection to an initial information source from a set of available information sources;
c) transmitting an initial request for applicant relevant information from the offer generation system to the initial information source via the established initial connection, wherein the initial transmitted request comprises at least a portion of the received applicant specified information;
d) receiving applicant relevant information from the initial information source;
e) generating an offer of insurance based at least in part upon the applicant information selected from the group consisting of received applicant specified information, received applicant relevant information and combinations thereof; and
f) transmitting the generated offer to an offer output device associated with the applicant.

2. The method of claim 1, and further comprising the step of transmitting a request for applicant specified information to a second output device associated with the applicant.

3. The method of claim 2, wherein the step of transmitting the request for applicant specified information comprises transmitting a form into which the applicant may enter the applicant specified information and wherein the step of receiving the applicant specified information comprises the steps of receiving a completed form into which the applicant specified information has been entered and parsing the applicant specified information from the transmitted form.

4. The method of claim 2, wherein the second output device associated with the applicant is selected from the group consisting of a computer, a telephone, a facsimile machine and combinations thereof.

5. The method of claim 4, wherein the second output device comprises a computer and wherein the computer comprises a display device selected from the group consisting of a monitor, a speaker, a tactile display, a printer and combinations thereof.

6. The method of claim 2, wherein the second output device is the offer output device.

7. The method of claim 1, and further comprising the steps of g) receiving payment information and h) processing the received payment information to receive compensation based upon the transmitted offer.

8. The method of claim 7, wherein the payment information comprises a payment type selected from the group consisting of charge card, debit card, direct bank account withdrawal, electronic fund transfer and combinations thereof.

9. The method of claim 1, and further comprising the step of g) receiving an acceptance signal indicating acceptance of the transmitted offer.

10. The method of claim 9, wherein the acceptance signal comprises payment information and further comprising the step of h) processing the received payment information to receive compensation based upon the accepted offer.

11. The method of claim 10, wherein the payment information comprises a payment type selected from the group consisting of charge card, debit card, direct withdrawal and electronic fund transfer.

12. The method of claim 10, and further comprising the step of i) delivering a policy to the applicant drawn in accordance with the accepted offer.

13. The method of claim 9, and further comprising the step of h) delivering a policy to the applicant drawn in accordance with the offer.

14. The method of claim 1, and further comprising the step of h) selecting the information source to which to establish the connection.

15. The method of claim 14, wherein the step of selecting the information source comprises accessing a data store comprising information source addressing information representing at least one information source.

16. The method of claim 15, wherein the data store comprises information source addressing information representing a plurality of information sources.

17. The method of claim 1, and further comprising the step of h) establishing a further connection to a further information source from the set of available information sources; i) transmitting a further request for applicant relevant information from the offer generation system to the further information source via the further established connection, wherein the further transmitted request comprises applicant information selected from the group consisting of previously received applicant relevant information, received applicant specified information and combination thereof; j) receiving further applicant relevant information from the further information source; and k) aggregating the received further applicant relevant information with any prior received applicant relevant information.

18. The method of claim 17, and further comprising the step of 1) repeating steps h) through k) for each of a selected subset of the set of available information sources.

19. The method of claim 18, and further comprising the step of 1) repeating steps h) through k) for each information source in the set of available information sources.

20. The method of claim 1, wherein the step of establishing the connection comprises the step of attempting to open the connection to the information source via a communication channel.

21. The method of claim 20, wherein the communication channel for attempting to open the connection is based upon addressing information associated with the information source.

22. The method of claim 20, wherein the communication channel is selected from the group consisting of: computer network, direct serial or parallel connection, dial-up connection, dedicated line connection, wireless connection, bus connection and combinations thereof.

23. The method of claim 22, wherein the communication channel is the Internet.

24. The method of claim 1, wherein the step of transmitting the request comprises transmitting the request via a protocol selected from the group consisting of HTTP, HTTPS, SMTP, FTP, BLUETOOTH, GOPHER and WAIS.

25. The method of claim 1, wherein the step of generating the offer of insurance comprises the step of generating a rate component of the offer of insurance.

26. The method of claim 25, wherein the step of generating the rate component comprises the steps of: i) determining an underwriting tier for the applicant based upon applicant information selected from the group consisting of received applicant specified information, received applicant relevant information and combinations thereof; ii) retrieving a base rate based upon the determined underwriting tier; and iii) calculating the rate component based upon the base rate and applicant information selected from the group consisting of received applicant specified information, received applicant relevant information and combinations thereof.

27. The method of claim 26, wherein the step of generating the rate component further comprises the steps of iv) deriving an adjustment to the retrieved base rate based at least in part upon applicant information selected from the group consisting of received applicant specified information, received applicant relevant information and combinations thereof and a dynamic pricing factor based upon analysis of analytic information selected from the group consisting of demand level, cost, return on assets and combinations thereof and wherein the step of calculating the rate is further based upon the derived adjustment.

28. The method of claim 27, and further comprising the step of g) generating an adjustment table of dynamic pricing factors based upon the analysis of analytic information and wherein the step of deriving the adjustment comprises the step of retrieving the adjustment from the generated adjustment table based upon applicant information selected from the group consisting of received applicant specified information, received applicant relevant information and combinations thereof.

29. The method of claim 28, wherein the analytic information comprises demand level and wherein the step of generating the adjustment table generates the adjustment table based at least in part upon conversion rates as an indicator of demand level, wherein the adjustment table generation step comprises the steps of i) analyzing conversion rates for previous purchases of insurance products; ii) forecasting conversion rates for potential further purchases based upon the analyzed conversion rates and iii) preparing the adjustment table based at least in part upon the analyzed and forecasted conversion rates.

30. The method of claim 25, wherein the step of generating the rate component comprises the steps of: i) determining an offering company from a plurality of available offering companies based upon applicant information selected from the group consisting of received applicant specified information, received applicant relevant information and combinations thereof and a dynamic pricing factor based upon analysis of analytic information selected from the group consisting of demand level, cost, return on assets and combinations thereof; ii) determining an underwriting tier from the determined offering company for the applicant based upon applicant information selected from the group consisting of received applicant specified information, received applicant relevant information and combinations thereof; iii) retrieving a base rate based upon the determined underwriting tier for the determined offering company; iv) calculating the rate component for the offering company based upon the base rate and applicant information selected from the group consisting of received applicant specified information, received applicant relevant information and combinations thereof and wherein the step of generating the offer of insurance further comprises the step of adding identification information associated with the determined offering company to the offer.

31. The method of claim 30, and further comprising the step of g) generating an offering company table of offering company identification information based upon the analysis of the analytical information and wherein the step of determining the offering company comprises the step of selecting offering company identification associated with a particular offering company from the generated offering company table based upon applicant information selected from the group consisting of received applicant specified information, received applicant relevant information and combinations thereof.

32. The method of claim 31, wherein the analytic information comprises demand level and wherein the step of generating the offering company table generates the offering company table based at least in part upon conversion rates as an indicator of demand level, wherein the offering company table generation step comprises the steps of i) analyzing conversion rates for previous purchases of insurance products; ii) forecasting conversion rates for potential further purchases based upon the analyzed conversion rates and iii) preparing the offering company table based at least in part upon the analyzed and forecasted conversion rates.

33. The method of claim 25, wherein the step of generating the rate component comprises the steps of: i) determining a pricing tier for the applicant based upon applicant information selected from the group consisting of received applicant specified information, received applicant relevant information and combinations thereof and a dynamic pricing factor based upon analysis of analytic information selected from the group consisting of demand level, cost, return on assets and combinations thereof; ii) retrieving a base rate based upon the determined pricing tier; and iii) calculating the rate component based upon the base rate and applicant information selected from the group consisting of received applicant specified information, received applicant relevant information and combinations thereof.

34. The method of claim 33, and further comprising the step of g) generating a table of dynamic pricing factors based upon the analysis of the analytic information and wherein the step of determining the pricing tier comprises the step of retrieving the dynamic pricing factor from the generated table based upon applicant information selected from the group consisting of received applicant specified information, received applicant relevant information and combinations thereof.

35. The method of claim 34, wherein the analytic information comprises demand level and wherein the step of generating the table generates the table based at least in part upon conversion rates as an indicator of demand level, wherein the table generation step comprises the steps of i) analyzing conversion rates for previous purchases of insurance products; ii) forecasting conversion rates for potential further purchases based upon the analyzed conversion rates and iii) preparing the table based at least in part upon the analyzed and forecasted conversion rates.

36. The method of claim 25, wherein the step of generating the offer of insurance further comprises the step of generating a fee component of the offer of insurance.

37. The method of claim 36, wherein the step of generating the offer of insurance further comprises the step of adjusting the generated rate component and the generated fee component based upon applicant information selected from the group consisting of received applicant specified information, received applicant relevant information and combinations thereof.

38. The method of claim 1, wherein the step of generating the offer of insurance comprises the step of generating a fee component of the offer of insurance.

39. The method of claim 38, wherein the step of generating the fee component comprises the step of determining a fee for the applicant based upon applicant information selected from the group consisting of received applicant specified information, received applicant relevant information and combinations thereof and a dynamic pricing factor based upon analysis of analytic information selected from the group consisting of demand level, cost, return on assets and combinations thereof.

40. The method of claim 39, and further comprising the step of g) generating a table of dynamic pricing factors based upon the analysis of the analytic information and wherein the step of determining the fee comprises the step of retrieving the dynamic pricing factor from the generated table based upon applicant information selected from the group consisting of received applicant specified information, received applicant relevant information and combinations thereof.

41. The method of claim 40, wherein the analytic information comprises demand level, wherein the step of generating the table generates the table based at least in part upon conversion rates as an indicator of demand level by performing the steps comprising of i) analyzing conversion rates for previous purchases of insurance products; ii) forecasting conversion rates for potential further purchases based upon the analyzed conversion rates and iii) preparing the table based at least in part upon the analyzed and forecasted conversion rates.

42. The method of claim 1, wherein the step of generating the offer of insurance comprises the step of generating a purchase incentive component of the offer of insurance.

43. The method of claim 42, wherein the purchase incentive component comprises at least one incentive selected from the group consisting of a discount on the offered insurance product, a discount on a third party product or service, an award in a third-party incentive program, and a free third party product or service.

44. The method of claim 1, wherein the offer output device associated with the applicant is selected from the group consisting of a computer, a telephone, a facsimile machine and combinations thereof.

45. An automated offer generation system for providing an offer of insurance for an applicant in real-time, the system comprising:
a) a system data store for storing information associated with the applicant;
b) a system processor comprising one or more processing units;
c) a link to at least one communication channel allowing communication between the system processor and one or more information sources;
wherein the system processor is in communication with the system data store and the link and wherein the system processor: i) receives applicant specified information; ii) establishes via the link an initial connection to an initial information source from a set of available information sources; iii) transmits via the link an initial request for applicant relevant information to the initial information source over the established initial connection, wherein the initial transmitted request comprises at least a portion of the received applicant specified information; iv) receives applicant relevant information from the initial information source; v) stores the received applicant relevant information in the system data store; vi) generates the offer of insurance based at least in part upon applicant information selected from the group consisting of received applicant specified information, received applicant relevant information and combinations thereof; and vii) transmits the generated offer to an offer output device associated with the applicant.

46. The system of claim 45, wherein the system processor further viii) transmits a request for applicant specified information to a second output device associated with the applicant.

47. The system of claim 46, wherein the second output device comprises a computer comprising a display device and wherein the display device is selected from the group consisting of a monitor, a speaker, a tactile display, a printer and combinations thereof.

48. The system of claim 46, wherein the second output device is the offer output device.

49. The system of claim 45, wherein the system processor further viii) receives payment information and ix) processes the received payment information to receive compensation based upon the transmitted offer.

50. The system of claim 49, wherein the system processor further x) delivers a policy to the applicant drawn according to the transmitted offer.

51. The system of claim 45, wherein the system processor further viii) stores the generated offer in the system data store in a record associated with the applicant.

52. The system of claim 51, wherein the system processor further ix) determines if a record comprising a previously generated offer exists in the data store associated with the applicant and wherein the system processor generates the offer of insurance by retrieving the previously generated offer.

53. The system of claim 45, wherein the system processor further viii) receives an acceptance signal indicating acceptance of the transmitted offer.

54. The system of claim 53, wherein the system processor further ix) receives payment information and x) processes the received payment information to receive compensation based upon the transmitted offer.

55. The system of claim 53, wherein the system processor further ix) delivers a policy to the applicant drawn according to the transmitted offer.

56. The system of claim 55, wherein the system processor delivers the policy to the applicant via a policy output device selected from the group consisting of a computer, a telephone, a facsimile machine and combinations thereof.

57. The system of claim 56, wherein the policy output device comprises a computer comprising a display device and wherein the display device is selected from the group consisting of a monitor, a speaker, a tactile display, a printer and combinations thereof.

58. The system of claim 55, wherein the system processor delivers the policy to the applicant via the offer output device.

59. The system of claim 45, and further comprising an information source data store in communication with the system processor and wherein the information source data store stores information source addressing information representing each information source in the set of available information sources.

60. The system of claim 59, wherein the system data store comprises the information source data store.

61. The system of claim 59, wherein the system processor further viii) selects from the set of available information sources the initial information source to which the initial connection has been established.

62. The system of claim 59, wherein the system processor further viii) establishes a further connection to a further information source from the set of available information sources; ix) transmits a further request for applicant relevant information to the further information source over the further established connection, wherein the further transmitted request comprises at least a portion of the received applicant specified information or information selected from any previously obtained applicant relevant information; x) receives further applicant relevant information from the further information sources; and xi) stores in the system data store the further applicant relevant information with any previously obtained applicant relevant information.

63. The system of claim 62, wherein the system processor further x) repeats viii) through xi) for each of a selected subset of the set of available information sources.

64. The system of claim 45, wherein the communication channel is selected from the group consisting of: computer network, direct serial or parallel connection, dial-up connection, dedicated line connection, wireless connection, bus connection and combinations thereof.

65. The system of claim 45, wherein the system processor generates a rate component of the offer of insurance as part of generating the offer of insurance.

66. The system of claim 65, wherein the system processor further generates a fee component of the offer of insurance as part of generating the offer of insurance.

67. The system of claim 66, wherein the system processor adjusts the generated rate component and the generated fee component based upon applicant information selected from the group consisting of received applicant specified information, received applicant relevant information and combinations thereof, as part of generating the offer of insurance.

68. The system of claim 65, wherein the system processor generates the rate component by at least: (1) determining an underwriting tier for the applicant based upon applicant information selected from the group consisting of received applicant specified information, received applicant relevant information and combinations thereof; (2) retrieving a base rate based upon the determined underwriting tier; and (3) calculating the rate component based upon the base rate and applicant information selected from the group consisting of received applicant specified information, received applicant relevant information and combinations thereof.

69. The system of claim 68, wherein the system processor, as part of generating the rate component, (4) derives an adjustment to the retrieved base rate based upon applicant information selected from the group consisting of received applicant specified information, received applicant relevant information and combinations thereof and a dynamic pricing factor based upon analysis of analytic information selected from the group consisting of demand level, cost, return on assets and combinations thereof and wherein the processor further bases the calculation of the rate component based upon the derived adjustment.

70. The system of claim 65, wherein the system processor generates the rate component by at least: (1) determining an offering company from a plurality of available offering companies based upon applicant information selected from the group consisting of received applicant specified information, received applicant relevant information and combinations thereof and a dynamic pricing factor based upon analysis of analytic information selected from the group consisting of demand level, cost, return on assets and combinations thereof; (2) determining an underwriting tier from the determined offering company for the applicant based upon applicant information selected from the group consisting of received applicant specified information, received applicant relevant information and combinations thereof; (3) retrieving a base rate based upon the determined underwriting tier for the determined offering company; (4) calculating the rate component for the offering company based upon the base rate and applicant information selected from the group consisting of received applicant specified information, received applicant relevant information and combinations thereof and wherein the system processor adds identification information associated with the determined offering company to the offer as part of generating the offer.

71. The system of claim 65, wherein the system processor generates the rate component by at least: (1) determining a pricing tier for the applicant based upon applicant information selected from the group consisting of received applicant specified information, received applicant relevant information and combinations thereof and a dynamic pricing factor based upon analysis of analytic information selected from the group consisting of demand level, cost, return on assets and combinations thereof; (2) retrieving a base rate based upon the determined pricing tier; and (3) calculating the rate component based upon the base rate and applicant information selected from the group consisting of received applicant specified information, received applicant relevant information and combinations thereof.

72. The system of claim 45, wherein the system processor generates a fee component of the offer of insurance as part of generating the offer of insurance.

73. The system of claim 45, wherein the system processor generates a purchase incentive component of the offer of insurance as part of generating the offer of insurance.

74. The system of claim 45, wherein the system processor comprises a plurality of processing units and wherein each processing unit supports a subset of actions i) through vii) performed by the system processor.

75. The system of claim 45, wherein the data store has an architecture selected from the group consisting of a flat file, a hash table, a database and combinations thereof.

76. The system of claim 75, wherein the data store comprises a database and wherein the database has an organization selected from the group consisting of hierarchical, object-oriented, relational, object-relational, spatial and combinations thereof.

77. The system of claim 45, wherein the offer output device is selected from the group consisting of a computer, a telephone, a facsimile machine and combinations thereof.

78. The system of claim 77, wherein the offer output device is a computer and wherein the computer comprises a display device selected from the group consisting of a monitor, a speaker, a tactile display, a printer and combinations thereof.

79. A computer readable storage device storing instructions that upon execution by a computer cause the computer to provide an offer of insurance to an applicant in real-time by performing the steps comprising of:
a) receiving applicant specified information associated with the applicant;
b) establishing connections with one or more information sources from a set of available information sources;
c) for each information source to which a connection has been established, transmitting a request for applicant relevant information from the computer to the information source via the established connection, wherein the transmitted request comprises at least a portion of the received applicant specified information or information selected from any applicant relevant information previously obtained from other information sources;
d) receiving applicant relevant information from at least one information source to which a request was transmitted;
e) generating an offer of insurance based at least in part upon applicant information selected from the group consisting of received applicant specified information, received applicant relevant information and combinations thereof by at least generating a rate component of the offer and a fee component of the offer; and
f) transmitting the generated offer to an offer output device associated with the applicant.

80. The storage device of claim 79, and storing further instructions that upon execution by the computer cause the computer to perform the step comprising of g) transmitting a request for applicant specified information to a second output device associated with the applicant, wherein the second output device is selected from the group consisting of a computer, a telephone, a facsimile machine and combinations thereof.

81. The storage device of claim 79, and storing further instructions that upon execution by the computer cause the computer to perform the steps comprising of g) receiving payment information and h) processing the received payment information to receive compensation based upon the transmitted offer.

82. The storage device of claim 79, and storing further instructions that upon execution by the computer cause the computer to perform the step comprising of g) storing the generated offer in a record associated with the applicant in a data store.

83. The storage device of claim 79, and storing further instructions that upon execution by the computer cause the computer to perform the step comprising of g) receiving an acceptance signal indicating acceptance of the transmitted offer.

84. The storage device of claim 83, and storing further instructions that upon execution by the computer cause the computer to perform the steps comprising of h) receiving payment information, wherein the payment information comprises a payment type selected from the group consisting of charge card, debit card, direct bank account withdrawal, electronic fund transfer and combinations thereof, and i) processing the received payment information to receive compensation based upon the transmitted offer.

85. The storage device of 84, wherein the stored instructions that upon execution cause the computer to perform the step of receiving payment information comprise instructions that cause the computer to receive the payment information by parsing the payment information from the received acceptance signal.

86. The storage device of claim 83, and storing further instructions that upon execution by the computer cause the computer to perform the steps comprising of h) delivering a policy to the applicant drawn in accordance with the transmitted offer.

87. The storage device of claim 79, wherein the stored instructions that upon execution cause the computer to perform the step of generating the offer comprise instructions that cause the computer to perform the further step comprising of adjusting the generated rate component and the generated fee component based upon applicant information selected from the group consisting of received applicant specified information, received applicant relevant information and combinations thereof.

88. The storage device of claim 79, wherein the stored instructions that upon execution cause the computer to perform the step of generating the offer comprise instructions that cause the computer to perform the further step comprising of generating a purchase incentive component of the offer of insurance, wherein the purchase incentive component comprises at least one incentive selected from the group consisting of a discount on the offered insurance product, a discount on a third party product or service, an award in a third-party incentive program, and a free third party product or service.

89. The storage device of claim 79, wherein the stored instructions that upon execution cause the computer to perform the step of generating the offer comprise instructions that cause the computer to generate the rate component by performing the steps comprising of: (1) determining an underwriting tier for the applicant based upon applicant information selected from the group consisting of received applicant specified information, received applicant relevant information and combinations thereof; (2) retrieving a base rate based upon the determined underwriting tier; and (3) calculating the rate component based upon the base rate and applicant information selected from the group consisting of received applicant specified information, received applicant relevant information and combinations thereof.

90. The storage device of claim 89, wherein the wherein the stored instructions that upon execution cause the computer to perform the step of generating the offer comprise instructions that cause the computer to generate the rate component by performing the further step comprising of: (4) deriving an adjustment to the retrieved base rate based upon applicant information selected from the group consisting of received applicant specified information, received applicant relevant information and combinations thereof and a dynamic pricing factor based upon analysis of analytic information selected from the group consisting of demand level, cost, return on assets and combinations thereof and wherein the instructions that upon execution cause the computer to calculate the rate component comprise instructions cause the computer to calculate the rate component based upon the derived adjustment as well as the base rate and applicant information selected from the group consisting of received applicant specified information, received applicant relevant information and combinations thereof.

91. The storage device of claim 79, wherein the stored instructions that upon execution cause the computer to perform the step of generating the offer comprise instructions that cause the computer to generate the rate component by performing the steps comprising of: (1) determining an offering company from a plurality of available offering companies based upon applicant information selected from the group consisting of received applicant specified information, received applicant relevant information and combinations thereof and a dynamic pricing factor based upon analysis of analytic information selected from the group consisting of demand level, cost, return on assets and combinations thereof; (2) determining an underwriting tier from the determined offering company for the applicant based upon applicant information selected from the group consisting of received applicant specified information, received applicant relevant information and combinations thereof; (3) retrieving a base rate based upon the determined underwriting tier for the determined offering company; (4) calculating the rate component for the offering company based upon the base rate and applicant information selected from the group consisting of received applicant specified information, received applicant relevant information and combinations thereof and that cause the computer to perform the step comprising of adding identification information associated with the determined offering company to the offer as part of generating the offer.

92. The storage device of claim 79, wherein the stored instructions that upon execution cause the computer to perform the step of generating the offer comprise instructions that cause the computer to generate the rate component by performing the steps comprising of: (1) determining a pricing tier for the applicant based upon applicant information selected from the group consisting of received applicant specified information, received applicant relevant information and combinations thereof and a dynamic pricing factor based upon analysis of analytic information selected from the group consisting of demand level, cost, return on assets and combinations thereof; (2) retrieving a base rate based upon the determined pricing tier; and (3) calculating the rate component based upon the base rate and applicant information selected from the group consisting of received applicant specified information, received applicant relevant information and combinations thereof.

93. An automated offer generation system for generating an offer of insurance for an applicant in real-time, the system comprising:
a) first communication means for communicating with the applicant;
b) second communication means for communicating with one or more information sources from a set of available information sources;
c) processing means in communication with the first and second communication means, the processing means for providing the offer to the applicant by performing the steps comprising of: i) receiving applicant specified information associated with the applicant via the first communication means; ii) establishing connections with one or more information sources from a set of available information sources via the second communication means; iii) for each information source to which a connection has been established, transmitting a request for applicant relevant information from the computer to the information source over the established connection, wherein the transmitted request comprises at least a portion of the received applicant specified information or information selected from any applicant relevant information previously obtained from other information sources; iv) receiving applicant relevant information from at least one of information sources over the established connection; v) generating an offer of insurance based at least in part upon applicant information selected from the group consisting of received applicant specified information, received applicant relevant information and combinations thereof by at least generating a rate component of the offer and a fee component of the offer; and vi) transmitting the generated offer to an offer output device associated with the applicant via the first communication means.

94. The system of claim 93, wherein the first communication means supports communication with the applicant via a communication channel selected from the group consisting of: computer network, direct serial or parallel connection, dial-up connection, dedicated line connection, wireless connection, bus connection and combinations thereof.

95. The system of claim 93, wherein the second communication means supports communication with the applicant via a communication channel selected from the group consisting of: computer network, direct serial or parallel connection, dial-up connection, dedicated line connection, wireless connection, bus connection and combinations thereof.

96. The system of claim 93, wherein the second communication means is the first communication means.

97. The system of claim 93, and further comprising data storage means for storing data associated with applicant.

98. The system of claim 97, wherein the processing means performs the further step comprising of vii) storing the generated offer in the data storage means in a record associated with the applicant.

99. The system of claim 97, wherein the processing means performs the further step comprising of vii) storing the received applicant relevant information in the data storage means in a record associated with the applicant.

100. The system of claim 99, wherein the processing means performs the further step comprising of viii) storing the generated offer in the data storage means in a record associated with the applicant.

101. The system of claim 93, wherein the processing means performs the further steps of vii) receiving payment information via the first communication means and viii) processing the received payment information to receive compensation based upon the transmitted offer.

102. The system of claim 93, wherein the processing means performs the further step of vii) receiving an acceptance signal indicating acceptance of the transmitted offer via the first communication means.

103. The system of claim 102, wherein the processing means performs the further step of viii) delivering a policy to the applicant drawn in accordance with the transmitted offer via the first communication means.
